(19) United States
(12) Patent Application Publication
(10) Pub. No.: US 2026/0278402 A1
(43) Pub. Date: Sep. 17, 2026

(54) MODEL INSTRUCTION-QUALITY EVALUATION METHOD AND APPARATUS, COMPUTER DEVICE, AND STORAGE MEDIUM

(71) Applicant: TENCENT TECHNOLOGY (SHENZHEN) COMPANY LIMITED, Shenzhen (CN)

(72) Inventor: Di LU, Shenzhen (CN)

(21) Appl. No.: 19/673,438

(22) Filed: May 11, 2026

Related U.S. Application Data
(63) Continuation of application No. PCT/CN2025/081265, filed on Mar. 7, 2025.

(30) Foreign Application Priority Data
Mar. 29, 2024 (CN) 202410383674.8

(51) Int. Cl. G06N 3/10; G06F 18/25

(52) U.S. Cl. CPC G06N 3/10; G06F 18/25

(57) ABSTRACT

A model instruction—quality evaluation method includes obtaining a model instruction and a plurality of sample sets, and for each sample set of the plurality of sample sets, fusing the model instruction with each quality evaluation sample in the sample set to obtain a model input set corresponding to the sample set, triggering, based on the model input set corresponding to the sample set, a machine learning model corresponding to the model instruction to perform a specified task specified by the model instruction, to obtain a task result set, and determining, based on accuracy of each task execution result in the task result set, a quality evaluation score of the model instruction. The method further includes determining a comprehensive quality evaluation score of the model instruction based on the quality evaluation scores obtained by evaluation based on the plurality of sample sets.

### CROSS-REFERENCE TO RELATED APPLICATIONS

This application is a continuation of International Application No. PCT/CN2025/081265, filed on Mar. 7, 2025, which claims priority to Chinese Patent Application No. 2024103836748, filed on Mar. 9, 2024 and entitled “MODEL INSTRUCTION—QUALITY EVALUATION METHOD AND APPARATUS, COMPUTER DEVICE, AND STORAGE MEDIUM,” the entire contents of both of which are incorporated herein by reference.

### FIELD OF THE TECHNOLOGY

This application relates to the field of computer technologies, and in particular, to a model instruction—quality evaluation method and apparatus, a computer device, and a storage medium.

### BACKGROUND OF THE DISCLOSURE

With development of science and technology, large models appear. Large models are a type of models in the field of machine learning and artificial intelligence, and are characterized by having a large quantity of parameters and a complex structure. These models usually include a plurality of layers of neural networks, and each layer includes a large quantity of neurons. A large model can usually capture complex patterns and relationships in data, to achieve excellent performance on various tasks, such as image recognition and natural language processing.

In an actual application process, an expression manner of a model instruction significantly affects a generation result of a large model. The model instruction (Prompt) usually refers to a prompt word or a prompt phrase, and is a paragraph of text instructions or descriptions inputted by a user to a large model, to guide the large model to generate a corresponding reply. After a large quantity of task-related model instructions are constructed, how to automatically evaluate the model instructions, grade quality of the model instructions, and further put a high-quality model instruction into production, to guide a large model to complete a task more accurately has very practical value.

Currently, quality evaluation on a model instruction is mainly manually performed; however, efficiency of manually performing quality evaluation on a model instruction is relatively low.

### SUMMARY

In accordance with the disclosure, there is provided a model instruction—quality evaluation method, performed by a computer device and including obtaining a model instruction and a plurality of sample sets, and for each sample set of the plurality of sample sets, fusing the model instruction with each quality evaluation sample in the sample set to obtain a model input set corresponding to the sample set, triggering, based on the model input set corresponding to the sample set, a machine learning model corresponding to the model instruction to perform a specified task specified by the model instruction, to obtain a task result set, and determining, based on accuracy of each task execution result in the task result set, a quality evaluation score of the model instruction. The method further includes determining a comprehensive quality evaluation score of the model instruction based on the quality evaluation scores obtained by evaluation based on the plurality of sample sets.

Also in accordance with the disclosure, there is provided a computer device including a memory storing computer-readable instructions, and a processor configured to execute the computer-readable instructions to obtain a model instruction and a plurality of sample sets, and for each sample set of the plurality of sample sets, fuse the model instruction with each quality evaluation sample in the sample set to obtain a model input set corresponding to the sample set, trigger, based on the model input set corresponding to the sample set, a machine learning model corresponding to the model instruction to perform a specified task specified by the model instruction, to obtain a task result set, and determine, based on accuracy of each task execution result in the task result set, a quality evaluation score of the model instruction. The processor is further configured to execute the computer-readable instructions to determine a comprehensive quality evaluation score of the model instruction based on the quality evaluation scores obtained by evaluation based on the plurality of sample sets.

Also in accordance with the disclosure, there is provided a non-transitory computer-readable storage medium storing computer-readable instructions stored that, when executed by a processor, cause an electronic device including the processor to obtain a model instruction and a plurality of sample sets, and for each sample set of the plurality of sample sets, fuse the model instruction with each quality evaluation sample in the sample set to obtain a model input set corresponding to the sample set, trigger, based on the model input set corresponding to the sample set, a machine learning model corresponding to the model instruction to perform a specified task specified by the model instruction, to obtain a task result set, and determine, based on accuracy of each task execution result in the task result set, a quality evaluation score of the model instruction. The computer-readable instructions, when executed by the processor, further cause the electronic device to is further configured to execute the computer-readable instructions to determine a comprehensive quality evaluation score of the model instruction based on the quality evaluation scores obtained by evaluation based on the plurality of sample sets

### BRIEF DESCRIPTION OF THE DRAWINGS

FIG. 1 is a diagram showing an application environment of a model instruction—quality evaluation method according to an embodiment;

FIG. 2 is a schematic flowchart of a model instruction—quality evaluation method according to an embodiment;

FIG. 3 is a schematic diagram showing determining a quality evaluation score according to an embodiment;

FIG. 4 is a schematic diagram showing determining a comprehensive quality evaluation score according to an embodiment;

FIG. 5 is a schematic diagram showing generating a sample set according to an embodiment;

FIG. 6 is a schematic diagram showing determining a sample weight according to an embodiment;

FIG. 7 is a schematic diagram showing determining a sample score according to an embodiment;

FIG. 8 is a schematic diagram showing a set weight according to an embodiment;

FIG. 9 is a schematic diagram showing overall determining a set weight according to an embodiment;

FIG. 10 is a schematic diagram showing generating a plurality of comprehensive quality evaluation scores according to an embodiment;

FIG. 11 is a schematic diagram showing applying of a high-quality model instruction according to an embodiment;

FIG. 12 is a schematic flowchart of a model instruction—quality evaluation method according to a specific embodiment;

FIG. 13 is a structural block diagram of a model instruction—quality evaluation apparatus according to an embodiment;

FIG. 14 is a diagram showing an internal structure of a computer device according to another embodiment; and

FIG. 15 is a diagram showing an internal structure of a computer device according to an embodiment.

### DESCRIPTION OF EMBODIMENTS

To make the objectives, technical solutions, and advantages of this application clearer, the following further describes this application in detail with reference to the accompanying drawings and embodiments. Specific embodiments described herein are only used for explaining this application, and are not used for limiting this application.

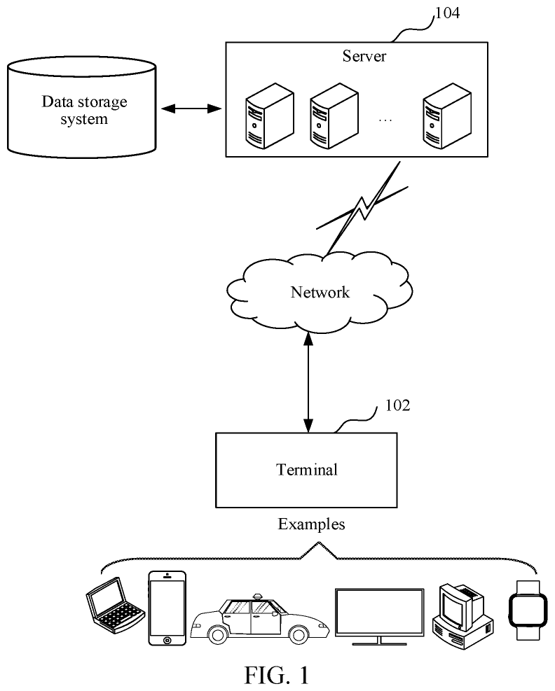

A model instruction—quality evaluation method provided in embodiments of this application may be applied to an application environment shown in FIG. 1. In the figure, a terminal 102 communicates with a server 104 through a network. A data storage system may store data that the server 104 needs to process. The data storage system may be integrated on the server 104, or may be placed on the cloud or another server. Both the terminal 102 and the server 104 may be independently configured to perform the model instruction—quality evaluation method provided in the embodiments of this application. The terminal 102 and the server 104 may alternatively be collaboratively configured to perform the model instruction—quality evaluation method provided in the embodiments of this application. An example in which the terminal 102 and the server 104 may be cooperatively configured to perform the model instruction—quality evaluation method provided in the embodiments of this application is used for description. The terminal 102 may obtain an input model instruction, and transmit the model instruction to the server 104, so that the server 104 performs quality evaluation on the model instruction based on a plurality of sample sets.

The terminal 102 may be, but not limited to, a desktop computer, a notebook computer, a smartphone, a tablet computer, an Internet of Things device, and a portable wearable device. The Internet of Things device may be a smart speaker, a smart television, a smart air condition, a smart in-vehicle device, or the like. The portable wearable device may be a smart watch, a smart band, a head-mounted device, or the like. The server 104 may be implemented by using an independent server or a server cluster that includes a plurality of servers.

“First,” “second,” and similar terms used in this application do not indicate any order, quantity, or significance, but are used to only distinguish different components. Unless the context clearly indicates otherwise, singular forms such as “one,” “a,” or “the” do not indicate a quantity limit, but rather indicate the existence of at least one. Quantities such as “a plurality of” or “a plurality of copies” mentioned in various embodiments of this application all refer to the quantity of “at least two.” For example, “a plurality of” refers to “at least two,” and “a plurality of copies” refers to “at least two copies.”

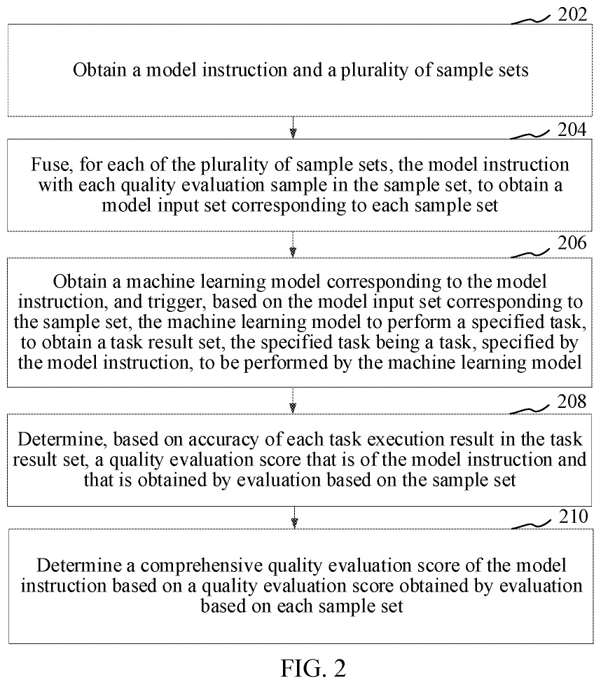

In an embodiment, as shown in FIG. 2, a model instruction—quality evaluation method is provided. An example in which the method is applied to a computer device is used for description, and the computer device may be the terminal or the server in FIG. 1. The model instruction—quality evaluation method includes the following operations.

Operation 202: Obtain a model instruction and a plurality of sample sets.

The model instruction, namely, a prompt, refers to a prompt word or a prompt phrase, and is used for being inputted to a machine learning model, to guide the machine learning model to generate a corresponding output. The model instruction may be a question, a sentence, a paragraph, or a group of instructions, to guide the machine learning model to output desired text, picture, or video.

The sample set includes at least one quality evaluation sample, and the quality evaluation sample is a sample used for evaluating quality of the model instruction. For example, a model instruction is “Please determine sentiment polarity (positive/neutral/negative) of the sentence <sentence>.” The model instruction is used for triggering the machine learning model to analyze sentiments of the sentence, and “analyze sentiments of the sentence” is a specified task. The quality evaluation sample may be a sentence. For example, the quality evaluation sample may be “Snowflakes falling, pleasant scenery.” Correspondingly, the quality evaluation sample may alternatively be a question and answer, a picture, a video, or the like.

Specifically, the computer device may obtain a model instruction on which quality evaluation is to be performed and obtain a plurality of sample sets for the quality evaluation on the model instruction. For example, a user may input, to the computer device, a model instruction on which quality evaluation is to be performed, and upload, in the computer device, a plurality of sample sets for the quality evaluation. In this way, the computer device may obtain the model instruction and the plurality of sample sets.

In an embodiment, each sample set may have a corresponding set weight, and each quality evaluation sample in each sample set may also have a corresponding sample weight. For each of the plurality of sample sets, the computer device may determine a set weight corresponding to the sample set. For example, when there is a sample set A, a sample set B, and a sample set C, the computer device separately determines set weights of the sample set A, the sample set B, and the sample set C. A larger set weight indicates greater importance of the sample set for the quality evaluation on the model instruction, and a better effect of an event of using the sample set to measure or evaluate “how accurate is a result obtained by triggering, by the model instruction, the machine learning model to perform a specified task T.” For example, there is a model instruction “Please determine sentiment polarity (positive/neutral/negative) of the sentence <sentence>,” and the model instruction triggers the machine learning model to perform a specified task T=“positive and negative information recognition task.” For the positive and negative information recognition task, there are three sample sets: a “short video comment sample set” (D1), an “ancient poem sample set” (D2), and an “English writing sample set” (D3). Because the positive and negative information recognition task is mainly applied to real-time harmful comment recognition, the “short video comment sample set” (D1) has highest importance for the quality evaluation on the model instruction, so that a set weight of the “short video comment sample set” (D1) is also the highest.

In addition to that each sample set may have a corresponding set weight, each quality evaluation sample in a single sample set may also have a corresponding sample weight. For example, in the foregoing example, the computer device needs to determine a sample weight corresponding to each quality evaluation sample in the sample set A, determine a sample weight corresponding to each quality evaluation sample in the sample set B, and determine a sample weight corresponding to each quality evaluation sample in the sample set C. A larger sample weight corresponding to a quality evaluation sample indicates greater importance of the quality evaluation sample. For example, there is a model instruction “Please determine sentiment polarity (positive/neutral/negative) of the sentence <sentence>,” and the model instruction triggers the machine learning model to perform a specified task T=“positive and negative information recognition task.” For a quality evaluation sample A “a danger event is about to happen to a subway station” and a quality evaluation sample B “smoking feels cool and banning smoking is annoying,” the machine learning model recognizes “a danger event is about to happen to a subway station” as “negative,” and recognize “smoking feels cool and banning smoking is annoying” as “negative,” and the former has greater importance. Therefore, the quality evaluation sample A needs to be correctly recognized by the machine learning model, and needs to be assigned with a relatively high sample weight, so that the sample is emphasized in the quality evaluation.

In an embodiment, a set weight corresponding to a sample set may be determined based on a correlation degree between the sample set and a specified task. A higher correlation degree indicates a higher set weight, and a higher set weight indicates that the sample set can be used for better evaluating quality of the model instruction. The specified task is a task, triggered by the model instruction, to be performed by the machine learning model. For example, the specified task may be the foregoing “positive and negative information recognition task.”

In an embodiment, the sample weight corresponding to the quality evaluation sample may be determined by using a pre-trained logistic regression model. The logistic regression model includes, but is not limited to, a. neural network regression, b. support vector regression (SVR), and c. decision tree regression. Logistic regression is also referred to as logistic regression analysis, is a generalized linear regression analysis model, and belongs to supervised learning in machine learning. A derivation process and a computation manner of logistic regression are similar to those of regression, but are actually mainly used for resolving a classification problem. A model is trained by using n given groups of data (training sets), and one or more given groups of data (test sets) are classified after the training ends. For example, some sample features of a quality evaluation sample are provided. Then, for a problem of determining whether the quality evaluation sample belongs to “important” or “unimportant” based on the sample features, sample features and corresponding sample weights of n quality evaluation samples may be obtained first, and the n groups of data are inputted to the logistic regression model for training. After the training, the sample features of the to-be-classified quality evaluation sample are inputted to the logistic regression models. Whether the quality evaluation sample belongs to “important” or “unimportant” is determined by using the logistic regression model. When the quality evaluation sample belongs to “important,” a sample weight of the quality evaluation sample is increased. When the quality evaluation sample belongs to “unimportant,” a sample weight of the quality evaluation sample is reduced.

Operation 204: Fuse, for each of the plurality of sample sets, the model instruction with each quality evaluation sample in the sample set, to obtain a model input set corresponding to each sample set.

The model input set includes at least one model input sample, and the model input sample may be a text, a question and answer, a picture, a video, or the like that is used for being inputted to the machine learning model. The machine learning model is a model including a plurality of layers of neural networks, and each layer of neural network includes a plurality of neurons. In this embodiment, the machine learning model may be specifically a large model, namely, a large-scale machine learning model.

Specifically, for each of the plurality of sample sets, the computer device fuses each quality evaluation sample in the sample set with the model instruction, to obtain a model input set corresponding to the sample set. For example, for the sample set A, the sample set A includes a quality evaluation sample a, a quality evaluation sample b, and a quality evaluation sample c. The computer device fuses the quality evaluation sample a with the model instruction to obtain a model input sample a, fuses the quality evaluation sample b with the model instruction to obtain a model input sample b, and fuses the quality evaluation sample c with the model instruction to obtain a model input sample c. The model input sample a, the model input sample b, and the model input sample c constitute a model input set corresponding to the sample set A.

In an embodiment, a manner of fusing the model instruction and the quality evaluation sample to obtain the model input sample may be specifically: filling the quality evaluation sample in a specified position of the model instruction, to obtain the model input sample. For example, when a model instruction is: “About whether <sentence> is positive, neutral, or negative, please provide a result,” for a quality evaluation sample: “Snowflakes falling, pleasant scenery,” the computer device fills “Snowflakes falling, pleasant scenery” in “About whether <sentence> is positive, neutral, or negative, please provide a result,” to obtain a model input sample: “About whether ‘Snowflakes falling, pleasant scenery’ is positive, neutral, or negative, please provide a result,” where <sentence> is a specified position in the model instruction.

Operation 206: Obtain the machine learning model corresponding to the model instruction, and trigger, based on the model input set corresponding to the sample set, the machine learning model to perform a specified task, to obtain a task result set, the specified task being a task, specified by the model instruction, to be performed by the machine learning model.

Specifically, because the model instruction may trigger the machine learning model to perform a corresponding task, the computer device may obtain the machine learning model corresponding to the model instruction. The machine learning model may be a model preset for the model instruction. For example, if there is a model instruction “Please determine sentiment polarity (positive/neutral/negative) of the sentence <sentence>,” a machine learning model corresponding to the model instruction may be a large language model, for example, a machine learning model A. The model instruction triggers the machine learning model A to perform a specified task T=“positive and negative information recognition task.” For another example, according to a model instruction “Please determine sentiment polarity (positive/neutral/negative) of the picture <picture>,” a machine learning model corresponding to the model instruction may be a picture recognition model, for example, a machine learning model B. The model instruction triggers the machine learning model B to perform a specified task T=“positive and negative information recognition task.”

Further, for each of the plurality of sample sets, the computer device obtains a model input set corresponding to the sample set, and inputs each model input sample in the model input set to the machine learning model, to trigger the machine learning model to perform a specified task, and output a corresponding task execution result. The specified task is a task, for example, the foregoing positive and negative sentiments determining task, that the model instruction guides the machine learning model to perform. Because each model input sample in the model input set corresponding to the sample set may trigger the machine learning model to output the corresponding task execution result, the task execution results constitute a task result set corresponding to the sample set. Each sample set may have a corresponding task result set.

Operation 208: Determine, based on accuracy of each task execution result in the task result set, a quality evaluation score that is of the model instruction and that is obtained by evaluation based on the sample set.

Specifically, for each task execution result in the task result set corresponding to the sample set, the computer device may determine the accuracy of each task execution result, and determine the quality evaluation score of the model instruction in the sample set based on the accuracy of each task execution result, in other words, determine the quality evaluation score that is of the model instruction and that is obtained by evaluation based on the sample set.

For example, higher accuracy of a task execution result indicates a higher quality evaluation score, and a larger quantity of accurate task execution results indicates a higher quality evaluation score. The quality evaluation score of the model instruction in the sample set represents a quality score that is evaluated for the model instruction based on the sample set. A larger quality evaluation score of the model instruction in the sample set indicates better quality of the model instruction evaluated based on the sample set. A smaller quality evaluation score of the model instruction in the sample set indicates lower quality of the model instruction evaluated based on the sample set. Better quality of the model instruction indicates that the model instruction can trigger the machine learning model to output a desired result. Lower quality of the model instruction indicates that a result outputted by the machine learning model triggered by the model instruction may not be ideal, which cannot satisfy a user requirement.

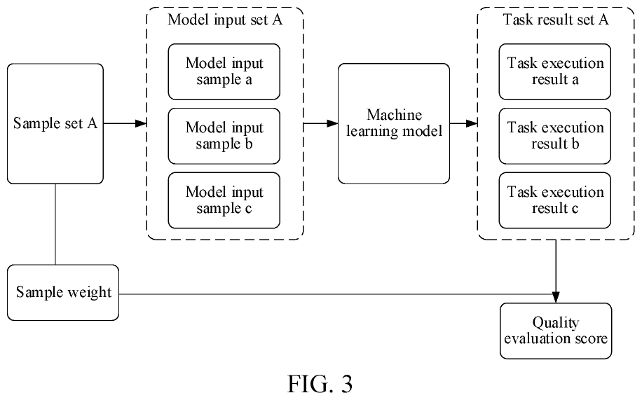

In an embodiment, for each of the plurality of sample sets, because each quality evaluation sample in the sample set has a corresponding sample weight, the computer device may further determine a quality evaluation score of the model instruction in the sample set based on the task result set and the sample weight corresponding to each quality evaluation sample in the sample set. For example, refer to FIG. 3. For a sample set A, the computer device may input, to the machine learning model, model input samples a to c in the model input set A corresponding to the sample set A, and process the model input samples a to c by using the machine learning model, to obtain task execution results a to c of the machine learning model for the model input samples a to c, so that the computer device may obtain a quality evaluation score of the model instruction in the sample set A based on the task execution results a to c and sample weights respectively corresponding to the quality evaluation samples a to c in the sample set. FIG. 3 is a schematic diagram showing determining a quality evaluation score according to an embodiment.

In an embodiment, that the computer device determines a quality evaluation score of the model instruction in the sample set based on the task result set and the sample weight corresponding to each quality evaluation sample in the sample set includes: The computer device may determine a sample score corresponding to each task execution result based on the accuracy of each task execution result in the task result set, and obtain the quality evaluation score based on the sample score corresponding to each task execution result and the sample weight corresponding to each quality evaluation sample in the sample set.

For example, for the sample set A, the sample set A includes the quality evaluation sample a and the quality evaluation sample b, and the computer device obtains the model input sample a based on the quality evaluation sample a, and obtains the model input sample b based on the quality evaluation sample b. The task execution result a is obtained based on the model input sample a and the machine learning model. When the task execution result a is correct, a sample score corresponding to the task execution result a is determined as a first score. When the task execution result a is incorrect, a sample score corresponding to the task execution result a is determined as a second score. The task execution result b is obtained based on the model input sample b and the machine learning model. When the task execution result b is correct, a sample score corresponding to the task execution result b is determined as a first score. When the task execution result b is incorrect, a sample score corresponding to the task execution result b is determined as a second score. The computer device may determine that the quality evaluation sample a corresponds to the task execution result a and the quality evaluation sample b corresponds to the task execution result b; multiply the sample weight corresponding to the quality evaluation sample a by the sample score corresponding to the task execution result a, to obtain a multiplication result a; and multiply the sample weight corresponding to the quality evaluation sample b by the sample score corresponding to the task execution result b, to obtain a multiplication result b. The computer device superimposes the multiplication result a and the multiplication result b and performs normalization, to obtain the quality evaluation score of the model instruction in the sample set A.

Operation 210: Determine a comprehensive quality evaluation score of the model instruction based on the quality evaluation score obtained by evaluation based on each sample set.

Specifically, after the quality evaluation score of the model instruction in each sample set is obtained, in other words, when the quality evaluation score obtained by evaluation based on each sample set is obtained, the computer device may determine the comprehensive quality evaluation score of the model instruction based on the quality evaluation score of the model instruction in each sample set. For example, the computer device may use an average value of the quality evaluation scores as the comprehensive quality evaluation score. The comprehensive quality evaluation score is a quality score evaluated for the model instruction based on full sample sets. The comprehensive quality evaluation score may represent accuracy of a task execution result obtained by triggering, based on the model instruction, the machine learning model to perform a task. A higher comprehensive quality evaluation score indicates higher accuracy of a task execution result obtained by triggering, based on the model instruction, the machine learning model to perform a corresponding task, and better quality of the model instruction. A lower comprehensive quality evaluation score indicates lower accuracy of a task execution result obtained by triggering, based on the model instruction, the machine learning model to perform a corresponding task, and lower quality of the model instruction.

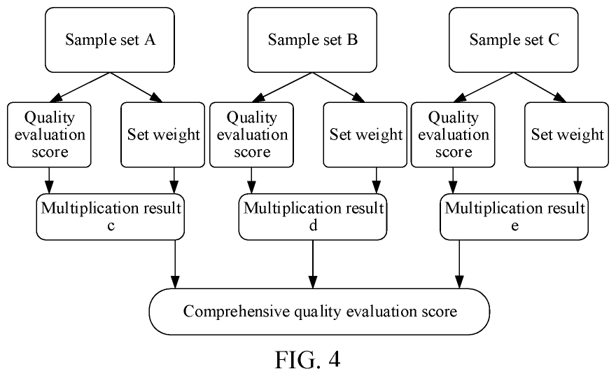

In an embodiment, because each sample set may have a corresponding set weight, the computer device may further determine the comprehensive quality evaluation score of the model instruction based on the set weight corresponding to each sample set and the quality evaluation score of the model instruction in each sample set. For example, refer to FIG. 4. The computer device multiplies quality evaluation scores of a model instruction in sample sets A to C by set weights of the corresponding sample sets, to obtain multiplication results c to e, and obtains a comprehensive quality evaluation score based on the multiplication results c to e, for example, superimposes the multiplication results c to e and performs normalization, to obtain the comprehensive quality evaluation score. FIG. 4 is a schematic diagram showing determining a comprehensive quality evaluation score according to an embodiment.

A task modality of a specified task may be an image, a voice, a text, or the like. A task type of the specified task may be: sentiment classification/professional examination/programming language/software development and problem searching/image understanding/mathematical and scientific problem resolving/comprehensive data analysis/fact checking/games and entertainment, or the like. The machine learning model may be a model applied to a specific field, such as health/finance/scientific research/education.

In the model instruction—quality evaluation method, the to-be-evaluated model instruction and the plurality of sample sets are obtained, so that the model instruction can be fused with each quality evaluation sample in each sample set, to obtain the model input set corresponding to each sample set. The model input set is obtained. For each of the plurality of sample sets, the task result set corresponding to the sample set may be outputted based on the machine learning model, and the quality evaluation score obtained by evaluation based on the sample set is obtained based on the accuracy of the task execution result in the task result set. The quality evaluation score obtained by evaluation based on each sample set is obtained, so that the comprehensive quality evaluation score of the model instruction can be obtained based on the quality evaluation score. Because the comprehensive quality evaluation score can be obtained automatically, compared with the approach of manually performing quality evaluation on a model instruction, this application can greatly improve evaluation efficiency of the quality evaluation. In addition, this application can be widely applied to actual production of large model instruction projects, and a large model is triggered, by searching for a high-quality model instruction, to output a more accurate result. In addition, compared with determining a comprehensive quality evaluation score based on only one sample set, jointly determining the comprehensive quality evaluation score of the model instruction based on the plurality of sample sets can reduce a probability that quality evaluation is inaccurate due to an excessively small quantity of sample sets, to improve accuracy of the model instruction—quality evaluation.

In an embodiment, the computer device may determine a plurality of data sources. For each of the plurality of data sources, the computer device may obtain a plurality of to-be-processed samples from the data source, and perform downsampling on the obtained plurality of to-be-processed samples, to obtain a sample set corresponding to the data source.

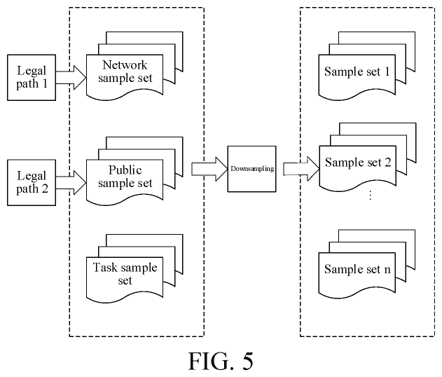

Specifically, the computer device collects to-be-processed samples from a plurality of data sources such as a network data source and a local data source. For example, refer to FIG. 5. The computer device may obtain a network sample set through a legal path, and obtain a public sample set and a task sample set through downloading. When the specified task is a positive and negative information recognition task, a to-be-processed sample in the network sample set, the public sample set, and the task sample set may be, for example, a text like a chat dialog/a movie dialog/a book script. Further, in consideration of a quantity of samples and compute resources required for evaluation, a quality evaluation target may be completed by maintaining n fixed-size sample sets. Therefore, the computer device performs downsampling on the obtained to-be-processed samples, and a sampling probability can be freely set as required. For example, to-be-processed samples may be selected from the network sample set by using a preset sampling probability, the selected to-be-processed sample is used as a quality evaluation sample, and these quality evaluation samples are used as a sample set. Quality evaluation samples may be selected from the public sample set by using a preset sampling probability, to obtain another sample set, and quality evaluation samples may be selected from the task sample set by using a preset sampling probability, to obtain still another sample set. FIG. 5 is a schematic diagram showing generating a sample set according to an embodiment.

In this embodiment, diversity of to-be-processed samples may be improved by obtaining the to-be-processed samples from a plurality of data sources, to improve accuracy of a determined comprehensive quality evaluation score based on the samples having diversity.

In an embodiment, the model input set includes a model input sample corresponding to each quality evaluation sample in the sample set. The fusing the model instruction with each quality evaluation sample in the sample set, to obtain a model input set corresponding to each sample set includes: determining an evaluation sample filling position in the model instruction based on a preset keyword; and filling, for each quality evaluation sample in the sample set, the quality evaluation sample in the evaluation sample filling position in the model instruction, to obtain the model input sample corresponding to the quality evaluation sample.

Specifically, when the model input set needs to be generated, the computer device determines the evaluation sample filling position based on the preset keyword. The preset keyword may be specifically an evaluation sample filling index. Therefore, the evaluation sample filling position may be determined based on the evaluation sample filling index. For example, when the model instruction is “Please determine sentiment polarity (positive/neutral/negative) of the sentence <sentence>,” the evaluation sample filling index is “<sentence>,” and a position of the evaluation sample filling index in the model instruction is the evaluation sample filling position.

Further, for each of the plurality of sample sets, the computer device performs the following operation: For each quality evaluation sample in the sample set, the computer device fill the quality evaluation sample in the evaluation sample filling position in the model instruction, to obtain a model input sample corresponding to the quality evaluation sample. For example, when the quality evaluation sample is “Snowflakes falling, pleasant scenery,” and the model instruction is “Please determine sentiment polarity (positive/neutral/negative) of the sentence <sentence>,” “<sentence>” may be filled in with “Snowflakes falling, pleasant scenery,” to obtain a model input sample “Please determine sentiment polarity (positive/neutral/negative) of the sentence <Snowflakes falling, pleasant scenery>.”

Further, when a model input sample corresponding to each quality evaluation sample in the sample set is obtained, the model input samples corresponding to all the quality evaluation samples in the sample set constitute a model input set corresponding to the sample set. For example, a sample set A has three quality evaluation samples a to c, and then three model input samples a to c that are generated based on the three quality evaluation samples a to c constitute a model input set corresponding to the sample set A.

In this embodiment, the evaluation sample filling index is set, so that it may be convenient to fill the quality evaluation sample in the evaluation sample filling position, to improve generation efficiency of the model input sample.

In an embodiment, the task result set includes a task execution result corresponding to each model input sample in the model input set. The triggering, based on the model input set corresponding to the sample set, the machine learning model to perform a specified task, to obtain a task result set includes: inputting, for each model input sample in the model input set corresponding to the sample set, the model input sample to the machine learning model, to trigger the machine learning model to output the task execution result corresponding to the model input sample.

Specifically, for each of the plurality of sample sets, after obtaining a model input set corresponding to the sample set, the computer device may input each model input sample in the model input set to the machine learning model, to obtain a task execution result corresponding to each model input sample outputted by the machine learning model, and the task execution results corresponding to all the model input samples constitute the task result set.

In this embodiment, each model input sample in the model input set triggers the machine learning model to output the corresponding task execution result, so that subsequently, the quality evaluation score may be determined comprehensively based on the plurality of task execution results. Compared with determining the quality evaluation score based on only a single task execution result, a probability that the quality evaluation score is inaccurate due to an incorrect task execution result can be reduced, to improve accuracy of the quality evaluation score.

In an embodiment, the determining, based on accuracy of each task execution result in the task result set, a quality evaluation score that is of the model instruction and that is obtained by evaluation based on the sample set includes: obtaining a sample weight corresponding to each quality evaluation sample in the sample set; determining accuracy of each task execution result in the task result set; and determining, based on the sample weight corresponding to each quality evaluation sample in the sample set and the accuracy of each task execution result in the task result set, the quality evaluation score that is of the model instruction and that is obtained by evaluation based on the sample set.

For each of the plurality of sample sets, before the quality evaluation score is determined based on the sample weight corresponding to each quality evaluation sample in the sample set, the sample weight corresponding to each quality evaluation sample in the sample set further needs to be determined, and accuracy of each task execution result in a task result set obtained based on the sample set is determined. Then, the quality evaluation score obtained by evaluation based on the sample set is determined based on the sample weight and the accuracy. The sample weight of the quality evaluation sample may be determined by using a pre-trained logistic regression model. The accuracy of the task execution result may be determined by using a third-party large model, or the accuracy of the task execution result may be determined manually.

In this embodiment, different quality evaluation samples have different importance. For example, in a positive and negative information recognition task, importance of a case in which “a subway station is about to explode” can be correctly recognized by the machine learning model needs to be higher than importance of a case in which “smoking feels cool and banning smoking is annoying” can be correctly recognized by the machine learning model. Therefore, the sample weights are set, so that a more important quality evaluation sample can be emphasized during the quality evaluation based on the sample weights. In this way, a high-quality model instruction that is subsequently selected based on the quality evaluation score can trigger the machine learning model to correctly process a sample similar to the important quality evaluation sample.

An operation of determining the sample weight includes: selecting a preset quantity of quality evaluation samples from each sample set; adding a sample weight to the selected quality evaluation sample; training a logistic regression model by using the selected quality evaluation sample and the added sample weight, to obtain a trained logistic regression model; and determining, based on the trained logistic regression model, a sample weight corresponding to a non-selected quality evaluation sample.

Specifically, when the sample weight corresponding to the quality evaluation sample in the sample set needs to be determined, the computer device may output, by using the logistic regression model, the sample weight corresponding to the quality evaluation sample. The logistic regression model needs to be trained before the sample weight corresponding to the quality evaluation sample is outputted by using the logistic regression model. More specifically, after obtaining the plurality of sample sets, the computer device may select a second preset quantity of quality evaluation samples from each sample set. For ease of description, the quality evaluation sample selected herein is referred to as a training sample below. For example, b quality evaluation samples may be selected from a sample set D1 as training samples, b quality evaluation samples may be selected from a sample set D2 as training samples, and b quality evaluation samples may be selected from a sample set D3 as training samples. Further, a sample weight may be manually added to each selected training sample, to use the added sample weight as a label. The computer device trains a logistic regression model by using the training samples and the labels corresponding to the training samples, to obtain a trained logistic regression model, and processes, by using the trained logistic regression model, a remaining quality evaluation sample that is in the sample set and to which no sample weight is added, in other words, determines, by using the trained logistic regression model, a sample weight corresponding to a non-selected quality evaluation sample.

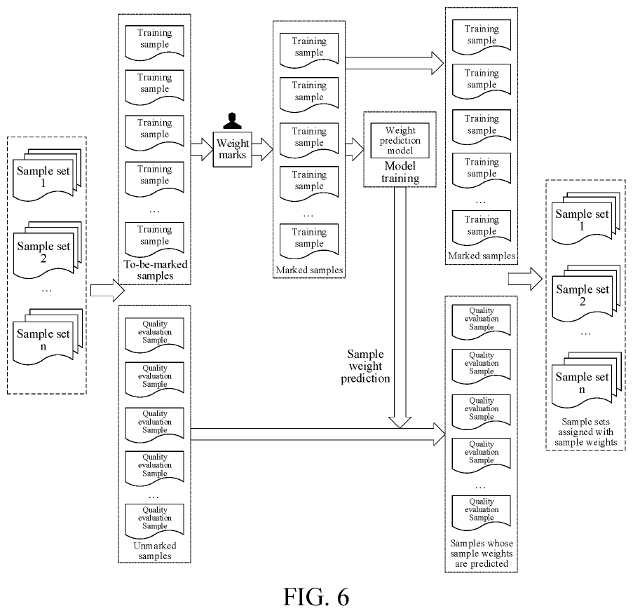

In an embodiment, FIG. 6 is a schematic diagram showing determining a sample weight according to an embodiment. Quality evaluation samples may be selected from a plurality of sample sets, the selected quality evaluation samples are used as training samples, and weight marks are added to the training samples, to obtain marked samples. Remaining quality evaluation samples are used as unmarked samples. A logistic regression model is trained by using the marked samples, to obtain a trained logistic regression model, and the unmarked samples are marked by using the trained logistic regression model.

In the foregoing embodiment, the quality evaluation samples are selected to train the logistic regression model, and a quantity of training samples can be reduced compared with training the logistic regression model by using full quality evaluation samples, to reduce a model computation amount and reduce resources such as power consumed during model computation.

In an embodiment, the determining, based on the trained logistic regression model, a sample weight corresponding to a non-selected quality evaluation sample includes: determining a sample feature of the non-selected quality evaluation sample; obtaining a model parameter matrix of the trained logistic regression model, and fusing the model parameter matrix with the sample feature, to obtain a fusion feature corresponding to the non-selected quality evaluation sample; and normalizing the fusion feature, to obtain the sample weight corresponding to the non-selected quality evaluation sample.

Specifically, when the sample weight of the non-selected quality evaluation sample needs to be outputted by using the trained logistic regression model, the trained logistic regression model may determine the sample feature of the non-selected quality evaluation sample. The sample weight of the non-selected quality evaluation sample refers to a sample weight of a quality evaluation sample that is not used as a training sample. The sample feature refers to information reflecting a feature of the quality evaluation sample. For example, a non-selected quality evaluation sample may be convolved by using a convolution network, and an obtained convolution result is the sample feature.

Further, the trained logistic regression model may construct model parameters as a model parameter matrix, and fuse the model parameter matrix with the sample feature, to obtain a fusion feature corresponding to the non-selected quality evaluation sample. For example, a fusion feature may be obtained by using the formula h_{θ}(eₓⱼ)=g(θ^{T}eₓⱼ), where eₓⱼ is a sample feature corresponding to a non-selected quality evaluation sample dₓⱼ, and θ is a model parameter matrix. Further, the computer device normalizes the fusion feature, to obtain a sample weight corresponding to the non-selected quality evaluation sample.

In the foregoing embodiment, the logistic regression model is pre-trained, and a quality evaluation sample to which no sample weight is added may be processed based on the trained logistic regression model, to obtain an accurate sample weight.

In an embodiment, a method for overall determining a sample weight includes the following operations.

Operation 1: Prepare data. Sample weights of an appropriate quantity of quality evaluation samples are marked. The marked sample weights are used for training a regression model. For example, in a positive and negative information recognition task (which is classified as “positive”/“neutral”/“negative”), a sample weight for recognizing “a danger event is about to happen to a subway station” as “negative” needs to be relatively high (for example, assigned value w=0.95), and a sample weight for recognizing “smoking feels cool and banning smoking is annoying” as “negative” needs to be lower than that of the former (for example, assigned value w=0.75). Samples whose proportion is U in a sample set D are marked. Herein, U=0.1 is set, to be specific, quality evaluation samples with a quantity of U×|D| are used as training samples for marking.

Operation 2: Train a logistic regression model. The logistic regression model is trained based on the training samples and the marked sample weights in operation 1. A formula of the logistic regression model is:

$${h}_{θ} ( {e}_{xj} ) = g ( {θ}^{T} {e}_{xj} )$$

$$z = {h}_{θ} ( {e}_{x j} )$$

$${w}_{x j} ( z ) = \frac{1}{1 + {e}^{- z}}$$

θ is all parameters (namely, a model parameter matrix) of the logistic regression model, eₓⱼ represents an eigenvector corresponding to a training sample dₓⱼ, and dₓⱼ is a j^{th} sample selected from an X^{th} sample set. h_{θ}(eₓⱼ) is a result obtained through a matrix operation by using a logistic regression parameter θ and the eigenvector. wₓⱼ(z) is a normalization function, which is for normalizing a computation result of the matrix operation to a real number (a floating point number) between [0, 1]. The floating point number is a sample weight wₓⱼ corresponding to the training sample dₓⱼ.

Operation 3: Automatically mark a weight of a remaining unmarked quality evaluation sample based on a trained logistic regression model in operation 2, in other words, obtain sample weights of all quality evaluation samples in all sample sets.

In an embodiment, the determining, based on the sample weight corresponding to each quality evaluation sample in the sample set and the accuracy of each task execution result in the task result set, the quality evaluation score that is of the model instruction and that is obtained by evaluation based on the sample set includes: determining, for each task execution result in the task result set, a quality evaluation sample that corresponds to the task execution result and that is in the sample set, and determining, based on the accuracy of the task execution result, a sample score corresponding to the corresponding quality evaluation sample; and determining, based on the sample weight and the sample score that correspond to each quality evaluation sample in the sample set, the quality evaluation score that is of the model instruction and that is obtained by evaluation based on the sample set.

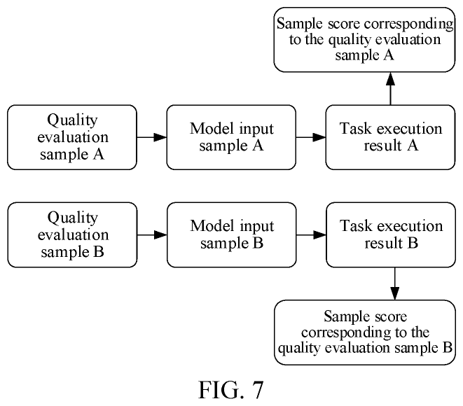

Specifically, because the task execution result is a result obtained after the machine learning model processes the model input sample, and the model input sample is generated by using the quality evaluation sample, there is a one-to-one correspondence between the task execution result and the quality evaluation samples. Therefore, for each task execution result in the task result set, a quality evaluation sample corresponding to each task execution result in the task result set may be determined based on the one-to-one correspondence. For example, refer to FIG. 7. Assuming that a sample set A includes a quality evaluation sample A and a quality evaluation sample B, a model input sample A is obtained based on the quality evaluation sample A, a model input sample B is obtained based on the quality evaluation sample B, a task execution result A is obtained based on the model input sample A, and a task execution result B is obtained based on the model input sample B, a quality evaluation sample corresponding to the task execution result A is the quality evaluation sample A, and a quality evaluation sample corresponding to the task execution result B is the quality evaluation sample B.

Further, when the quality evaluation sample corresponding to each task execution result in the task result set is determined, for each task execution result in the task result set, the computer device obtains, based on accuracy of the task execution result, a sample score corresponding to the corresponding quality evaluation sample. For example, a sample score corresponding to the quality evaluation sample A is obtained based on accuracy of the task execution result A, and a sample score corresponding to the quality evaluation sample B is obtained based on accuracy of the task execution result B.

Further, for each of the plurality of sample sets, the computer device determines a quality evaluation score of the model instruction in the sample set based on a sample weight and a sample score that correspond to each quality evaluation sample in the sample set. FIG. 7 is a schematic diagram showing determining a sample score according to an embodiment.

In an embodiment, the obtaining, based on accuracy of the task execution result, a sample score corresponding to the corresponding quality evaluation sample includes: determining, when the task execution result is correct, that the sample score corresponding to the corresponding quality evaluation sample is a first score; and determining, when the task execution result is incorrect, that the sample score corresponding to the corresponding quality evaluation sample is a second score. The first score may be “1,” and the second score may be “0.” When the task execution result is correct, the sample score is set to a relatively large score, or when the task execution result is incorrect, the sample score is set to a relatively small score, so that a high-quality model instruction that is subsequently selected based on the quality evaluation score can trigger the machine learning model to output a correct result. This improves accuracy of a model output result.

In an embodiment, a correct result of the machine learning model for each model input sample may be preset, so that the computer device may determine accuracy of a task execution result based on the set correct result. Alternatively, a task execution result may be presented, and accuracy of the task execution result is determined manually. Alternatively, a task model may be pre-trained (for example, a task execution result correctness determining layer is added to the foregoing machine learning model), and correctness of a task execution result is determined by using the task model. For example, a positive and negative information recognition task is used as an example. For a model instruction “About whether <sentence> is positive, neutral, or negative, please provide a result,” and for a quality evaluation sample “Snowflakes falling, pleasant scenery,” the model instruction and the quality evaluation sample are fused, to construct a model input sample “About whether ‘Snowflakes falling, pleasant scenery’ is positive, neutral, or negative, please provide a result.” The pre-trained task model outputs a prediction result after processing the model input sample. If the task model outputs the task model as a character string “correct,” it is considered that the model instruction can guide the machine learning model to correctly process the quality evaluation sample and obtain a correct result, a sample score corresponding to the quality evaluation sample “Snowflakes falling, pleasant scenery” is 1; otherwise, a sample score corresponding to the quality evaluation sample “Snowflakes falling, pleasant scenery” is 0.

In the foregoing embodiment, the task execution result is converted into the corresponding sample score, to subsequently determine the quality evaluation score based on the sample score.

In an embodiment, the determining, based on the sample weight and the sample score that correspond to each quality evaluation sample in the sample set, the quality evaluation score of the model instruction in the sample set includes: superimposing the sample weight corresponding to each quality evaluation sample in the sample set, to obtain a first superimposition weight; multiplying, for each quality evaluation sample in the sample set, the sample score corresponding to the quality evaluation sample by the corresponding sample weight, to obtain a first multiplication score corresponding to the quality evaluation sample; superimposing the first multiplication score corresponding to each quality evaluation sample in the sample set, to obtain a first superimposition score; and dividing the first superimposition score by the first superimposition weight, to obtain the quality evaluation score that is of the model instruction and that is obtained by evaluation based on the sample set.

Specifically, for each of the plurality of sample sets, the computer device superimposes a sample weight corresponding to each quality evaluation sample in the sample set, to obtain a first superimposition weight. For example, when the sample set includes a quality evaluation sample A, a quality evaluation sample B, and a quality evaluation sample C, a sample weight corresponding to the quality evaluation sample A is 1, a sample weight corresponding to the quality evaluation sample B is 0.5, and a sample weight corresponding to the quality evaluation sample C is 0.3, the computer device superimposes 1, 0.5, and 0.3, to obtain a first superimposition weight 1.8. Further, because each quality evaluation sample in the sample set has a corresponding sample weight and sample score, for each quality evaluation sample in the sample set, the computer device multiplies a sample score and a sample weight that correspond to the quality evaluation sample, to obtain a first multiplication score corresponding to the quality evaluation sample. For example, when a sample score of the quality evaluation sample A is 1, a sample score of the quality evaluation sample B is 1, and a sample score of the quality evaluation sample C is 0, a corresponding first multiplication score for the quality evaluation sample A is 1×1=1, a corresponding first multiplication score for the quality evaluation sample B is 1×0.5=0.5, and a corresponding first multiplication score is 0×0.3=0 for the quality evaluation sample C.

Further, the computer device superimposes the first multiplication score corresponding to each quality evaluation sample in the sample set, to obtain a first superimposition score. For example, the computer device superimposes 1, 0.5, and 0, to obtain a first superimposition score 1.5. Further, the computer device divides the first superimposition score by the first superimposition weight, to obtain a quality evaluation score of the model instruction in the sample set. For example, the computer device divides 1.5 by 1.8, to obtain a quality evaluation score 0.833.

In an embodiment, the computer device may determine a quality evaluation score Sₓᵢ of a model instruction pᵢ in a sample set Dₓ:

$$∀ {d}_{x j} ∈ {D}_{j} , {S}_{x i} = \frac{{\sum }_{x = 1}^{\vert {D}_{j} \vert} {w}_{x j} * {score}_{xij}}{{\sum }_{x = 1}^{\vert {D}_{j} \vert} {w}_{x j}}$$

pᵢ represents an i^{th} model instruction in a model instruction set; wₓⱼ is a sample weight corresponding to a quality evaluation sample dₓⱼ; dₓⱼ is a j^{th} quality evaluation sample in an X^{th} sample set; scoreₓᵢⱼ is a sample score corresponding to the quality evaluation sample dₓⱼ; |Dⱼ| is a total quantity of quality evaluation samples in the sample set Dₓ; and Sₓⱼ∈[0,1], to be specific, a value range of Sₓⱼ is a real number from 0 to 1. A higher quality evaluation score indicates better quality of the model instruction evaluated based on the sample set; and a lower quality evaluation score indicates poorer quality of the model instruction evaluated based on the sample set.

In the foregoing embodiment, different quality evaluation samples have different importance. Therefore, the sample weights are set, so that a more important quality evaluation sample can be emphasized during the quality evaluation based on the sample weights. In this way, a high-quality model instruction that is subsequently selected based on the quality evaluation score can trigger the machine learning model to correctly process a sample similar to the important quality evaluation sample.

For example, for a quality evaluation sample A “a danger event is about to happen to a subway station” and a quality evaluation sample B “smoking feels cool and banning smoking is annoying,” a sample weight of the quality evaluation sample A is higher than a sample weight of the quality evaluation sample B. Therefore, in a process of performing quality evaluation on a model instruction “About whether <sentence> is positive, neutral, or negative, please provide a result” based on the quality evaluation sample A and the quality evaluation sample B, a quality evaluation result of the model instruction based on the quality evaluation sample A is more emphasized. The quality evaluation result of the model instruction based on the quality evaluation sample A refers to a sample score corresponding to the quality evaluation sample A. A more correct recognition result of sentiment recognition performed by the machine learning model on the quality evaluation sample A indicates a higher sample score corresponding to the quality evaluation sample A, and a higher sample score indicates a higher quality evaluation score.

Compared with the quality evaluation sample B, because the sample weight of the quality evaluation sample A is higher than that of the quality evaluation sample B, an effect of the sample score corresponding to the quality evaluation sample A on the quality evaluation score is higher than an effect of a sample score corresponding to the quality evaluation sample B on the quality evaluation score. Therefore, compared with the quality evaluation sample B, a more correct recognition result of sentiment recognition performed by the machine learning model on the quality evaluation sample A indicates a higher possibility that the model instruction “About whether <sentence> is positive, neutral, or negative, please provide a result” is a high-quality model instruction. Therefore, when the model instruction “About whether <sentence> is positive, neutral, or negative, please provide a result” is subsequently applied to actual production, a recognition result of performing sentiment recognition on a text similar to the quality evaluation sample A by the machine learning model is more accurate, for example, a recognition result of performing sentiment recognition on a security-related text is more accurate.

In an embodiment, the determining a comprehensive quality evaluation score of the model instruction based on the quality evaluation score obtained by evaluation based on each sample set includes: obtaining a set weight corresponding to each of the plurality of sample sets; and determining the comprehensive quality evaluation score of the model instruction based on the set weight corresponding to each of the plurality of sample sets and the quality evaluation score obtained by evaluation based on each sample set.

Specifically, because the sample set has a corresponding sample weight, the comprehensive quality evaluation score of the model instruction may be determined based on the set weight corresponding to each of the plurality of sample sets and the quality evaluation score obtained by evaluation based on each sample set. For example, for each sample set, the set weight corresponding to the sample set may be multiplied by the quality evaluation score obtained by evaluation based on the sample set, to obtain a third multiplication score, and an average value of the third multiplication scores is used as the comprehensive quality evaluation score.

In an embodiment, the model instruction—quality evaluation method further includes an operation of determining the set weight, and the operation of determining the set weight corresponding to each of the plurality of sample sets includes: determining, according to the model instruction, the specified task that needs to be performed by the machine learning model; determining a correlation degree between each sample set and the specified task; and determining, based on the correlation degree between each sample set and the specified task, the set weight corresponding to each sample set.

Specifically, the computer device determines the specified task that needs to be performed by the machine learning model corresponding to the model instruction. For example, if the model instruction is “Please determine sentiment polarity (positive/neutral/negative) of the sentence <sentence>,” the specified task that needs to be performed by the machine learning model corresponding to the model instruction is a positive and negative information recognition task. Further, the computer device determines the correlation degree between each sample set and the specified task, and determines, based on the correlation degree between each sample set and the specified task, the set weight corresponding to each sample set. A higher correlation degree indicates a higher set weight.

In an embodiment, a set weight R(T)={r1, r2 . . . rn}, rx∈=[0, 1]} is assigned to a sample set D={D1, D2 . . . . Dn}, to be specific, a value range of the set weight is a real number from 0 to 1. A larger value of rx indicates that a sample set Dx can be used for better measuring or evaluating quality of the model instruction.

In an embodiment, the set weight may be manually determined. For example, for a specified task T=“positive and negative information recognition task,” on the positive and negative information recognition task (a text is classified as “positive”/“neutral”/“negative”), there are three sample sets: a “short video comment sample set” (D1), an “ancient poem sample set” (D2), and an “English writing sample set” (D3). For an application scenario of the specified task (the positive and negative information recognition task is mainly applied to real-time harmful comment recognition), a correlation degree relationship between the three sample sets and the specified task needs to be D1>D2≈D3, and therefore, a set weight relationship needs to be r1>r2≈r3. Herein, based on the correlation degree and a matching degree between the specified task and the sample set, a value of the set weight may be manually adjusted (if it is manually determined that a sample set Dx is similar to the specified task, a set weight of the sample set Dx is increased). For the three sample sets in the foregoing example, values of set weights may be assigned as r1=0.9, r2=0.3, and r3=0.3.

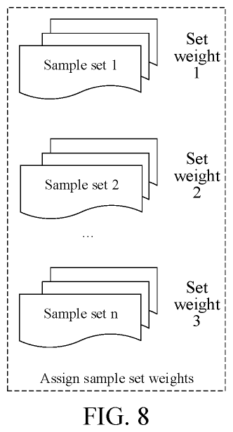

The set weight corresponding to each sample set may alternatively be determined by using a set weight determining model. The set weight determining model is a trained machine learning model used for determining the set weight. A result outputted by the set weight determining model may be shown in FIG. 8. FIG. 8 is a schematic diagram showing a set weight according to an embodiment.

In the foregoing embodiment, a higher correlation degree between the sample set and the specified task indicates greater importance of the sample set, so that the sample set can be used for better evaluating quality of the model instruction. Therefore, the set weight can be accurately determined based on the correlation degree between the sample set and the specified task.

In an embodiment, the determining a correlation degree between each sample set and the specified task includes: determining task description information of the specified task, a sample set identifier of each sample set, and a selected sample in each sample set; generating a construction instruction based on the task description information, the sample set identifier of each sample set, and the selected sample in each sample set; and determining, according to the construction instruction, the correlation degree between each sample set and the specified task.

Specifically, because the correlation degree between the sample set and the specified task may be obtained by using the set weight determining model, when the correlation degree between the sample set and the specified task needs to be determined, the computer device may first determine the task description information of the specified task. The task description information is information used for describing a task, and may include a task requirement. For example, task description information T may be: a “positive and negative information recognition task.” In the positive and negative information recognition task, a text is classified as “positive”/“neutral”/“negative.”

Further, the computer device may obtain the sample set identifier of each sample set. The sample set identifier refers to information that uniquely identifies one sample set. For example, the sample set identifier may be an identifier (ID) of the sample set. In addition, the computer device may select a first preset quantity of quality evaluation samples from each sample set. For ease of description, the selected quality evaluation sample is referred to as a selected sample below.

Further, the computer device may generate the construction instruction based on the task description information, the sample set identifier of each sample set, and the selected sample in each sample set, and trigger, according to the construction instruction, the set weight determining model to output the correlation degree between each sample set and the specified task.

In an embodiment, the computer device may determine, based on a quantity of quality evaluation samples in each sample set, a quantity of selected samples that are selected. For example, when a quantity of quality evaluation samples in the sample set is larger, a larger quantity of selected samples is selected. Alternatively, a selection quantity may be preset first, and selected samples are selected from the sample set based on the preset selection quantity. For example, the selection quantity may be a, and the computer device selects a selected samples from each sample set.

In an embodiment, the set weight determining model may be triggered, according to the construction instruction, to sort the sample sets based on the correlation degrees, to obtain a sample set sequence. For example, the set weight determining model may be triggered to sort the sample sets in descending order of the correlation degrees, so that a 1^{st} sample set in the sample set sequence has a highest correlation degree with the specified task, and subsequent sample sets have descending correlation degrees with the specified task.

In the foregoing embodiment, the construction instruction is generated, and the machine learning model may be triggered, according to the construction instruction, to automatically output the correlation degree between each sample set and the specified task, to improve correlation degree determining efficiency.

In an embodiment, the generating a construction instruction based on the task description information, the sample set identifier of each sample set, and the selected sample in each sample set includes: obtaining an initial construction instruction, where the initial construction instruction includes an information filling index, a set filling index corresponding to each sample set, and a selected sample filling index corresponding to each sample set; and filling the task description information in a position indicated by the information filling index, filling the sample set identifier of each sample set in a position indicated by the corresponding set filling index, and filling a sample identifier of each selected sample in a position indicated by the corresponding selected sample filling index, to obtain the construction instruction.

Specifically, the computer device may obtain the preset initial construction instruction. The initial construction instruction includes the information filling index, the set filling index, and the selected sample filling index. For example, the initial construction instruction may be: In a task background of <T>, D1 (<sample set identifier 1>)/D2 (<sample set identifier 2>)/D3 (<sample set identifier 3>) is used for evaluating quality of a model instruction, and an order of correlations between the sample sets and a specified task needs to be provided. A selected sample of D1 is (<selected sample 1>), a selected sample of D2 is (<selected sample 2>), and a selected sample of D3 is (<selected sample 3>). <T> in the initial construction instruction is an information filling index; <sample set identifier 1>, <sample set identifier 2>, and <sample set identifier 3> in the initial construction instruction are set filling indexes; and <selected sample 1>, <selected sample 2>, and <selected sample 3> in the initial construction instruction are selected sample filling indexes.

Further, the computer device may fill task information in a position indicated by the information filling index, for example, replace <T> in the initial construction instruction with the task information. The computer device fills the sample set identifier in the position indicated by the corresponding set filling index. For example, the computer device replaces <sample set identifier 1> in the initial construction instruction with an identifier of the sample set D1, replaces <sample set identifier 2> in the initial construction instruction with an identifier of the sample set D2, and replaces <sample set identifier 3> in the initial construction instruction with an identifier of the sample set D3. The computer device fills the sample identifier of the selected sample in the position indicated by the selected sample filling index. For example, if only one selected sample is selected from each sample set, the computer device replaces <selected sample 1> in the initial construction instruction with an identifier of a selected sample L1 selected from the sample set D1, replaces <selected sample 2> in the initial construction instruction with an identifier of a selected sample L2 selected from the sample set D2, replaces <selected sample 3> in the initial construction instruction with an identifier of a selected sample L3 selected from the sample set D3. In this way, a construction instruction can be obtained.

In this embodiment, the filling index is preset in the initial construction instruction, so that the computer device can be guided, based on the filling index, to accurately fill corresponding information in a corresponding position. In this way, an accurate construction instruction can be obtained, and accuracy of correlation determining can be improved according to the accurately generated construction instruction.

In an embodiment, the determining, based on the correlation degree between each sample set and the specified task, a set weight corresponding to each sample set includes: determining a quantity of sample sets in the plurality of sample sets, and determining a level interval based on the quantity of sample sets; sorting the sample sets in the plurality of sample sets in descending order of the correlation degrees, to obtain a sample set sequence; and determining, based on the level interval and a ranking of each sample set in the sample set sequence, the set weight corresponding to each sample set. The level interval is a reciprocal of the quantity of sample sets in the plurality of sample sets.

Specifically, the computer device may determine a quantity of obtained sample sets, in other words, determine the quantity of sample sets included in the plurality of sample sets, and determine the level interval based on the quantity of sample sets. For example, the level interval g=1/n. When three sample sets are obtained, the level interval g is ⅓. n is the quantity of sample sets. The computer device sorts the sample sets in descending order of the correlation degrees, to obtain the sample set sequence. What is recorded in the sample set sequence is the sample set identifier of each sample set. For example, if a correlation between a sample set D1 and a specified task is greater than a correlation between a sample set D2 and the specified task, and the correlation between the sample set D2 and the specified task is greater than a correlation between a sample set D3 and the specified task, the sample set sequence is {D1, D2, D3}.

Further, the computer device determines, based on the level interval and the ranking of each sample set in the sample set sequence, the set weight corresponding to each sample set. For example, the computer device may determine a set weight generation manner based on the quantity of sample sets, and determine, based on the set weight generation manner, the level interval, and the ranking of each sample set in the sample set sequence, the set weight corresponding to each sample set. For example, when the quantity of sample sets is three, the computer device automatically determines the set weight based on three levels.

For another example, the computer device traverses the sample set identifiers in the sample set sequence. For a sample set identifier that is currently traversed to, the computer device determines a ranking of the sample set identifier that is currently traversed to in the sample set sequence, obtains a corresponding initial set weight based on the ranking, and adjusts the initial set weight based on the level interval, to obtain a set weight corresponding to the sample set identifier that is currently traversed to. For example, when the sample set identifier that is currently traversed to is D1, because D1 is a 1st identifier in the sample set sequence, the computer device determines that an initial set weight corresponding to D1 is n×g. When the level interval g is ⅓, a set weight corresponding to D1 is 3×(⅓)=1. The computer device continues to perform traversing, to obtain a new sample set identifier D2 that is currently traversed to. The computer device determines that an initial set weight corresponding to D2 is (n−1)×g. When the level interval g is ⅓, a set weight corresponding to D2 is (3-1)×(⅓)=⅔.

In an embodiment, the computer device stores initial set weight sequences corresponding to different quantities of sample sets, and a quantity of initial set weights in the initial set weight sequence is consistent with the quantity of sample sets. For example, when the quantity of sample sets is three, the initial set weight sequence may be {n×g, (n−1)×g, (n−2)×g}, where n is the quantity of sample sets, and g is the level interval. The computer device performs one-to-one correspondence on the sample set identifier in the sample set sequence and the initial set weight in the initial set weight sequence based on a ranking of the sample set identifier in the sample set sequence and a ranking of the initial set weight in the initial set weight sequence. In this way, an initial set weight corresponding to each sample set identifier may be obtained. For example, a 1^{st} sample set identifier may correspond to a 1^{st} initial set weight, and a 2^{nd} sample set identifier may correspond to a 2^{nd} initial set weight. Then, the computer device may adjust each initial set weight by using a specific level interval, to obtain the set weight corresponding to each sample set.

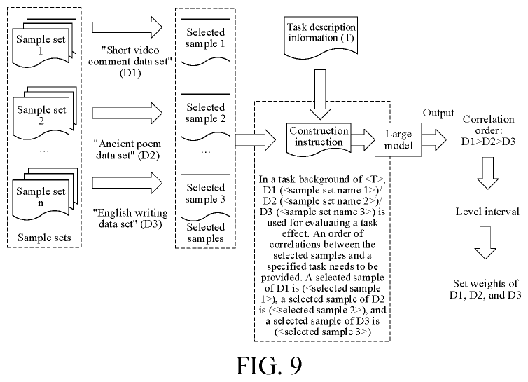

In the foregoing embodiment, the level interval is set, so that the set weight may be controlled, based on the level interval, to be not greater than 1. The level interval and the initial set weight are set, so that the set weight related to the correlation degree may be obtained based on the level interval and the initial set weight. The sample sets are sorted in descending order of the correlation degrees, so that a sample set ranked higher in the sample set sequence is a set more correlated to the specified task, so that a sample set having a higher correlation degree with the specified task can have a higher set weight based on the sample set sequence. A sample set having a higher correlation degree with the specified task can have a higher set weight, and a sample set having a higher correlation degree with the specified task can be considered as a sample set more important during the quality evaluation. Therefore, a more important sample set can be emphasized during the quality evaluation based on the set weights. In this way, a high-quality model instruction that is subsequently selected based on the comprehensive quality evaluation score can trigger the machine learning model to correctly process a sample similar to the important sample set, to improve accuracy of a model output result. In an embodiment, FIG. 9 is a schematic diagram showing overall determining a set weight according to an embodiment.

Operation 1: Perform sampling on samples, a samples are self-sampled from a sample set D={D1, D2, D3} as selected samples of each sample set.

Operation 2: Generate task description information. A task requirement and a task background of a specified task are described in words.

Operation 3: Collect a sample set identifier of each sample set, for example, a sample set name.

Operation 4: Construct a prompt instruction (namely, a construction instruction). Information collected in operations 1, 2, and 3 is constructed as the instruction, to guide a model to provide a correlation order.

Operation 5: Output a result and perform processing. A quantity of sample sets is used as a quantity of levels. A weight ranked first is n×g, and a weight ranked second is (n−1)×g. By analogy, a set weight may be automatically computed.

For example, a model output result is D1> D2>D3. A corresponding weight score R(T)={r1, r2, r3} may be automatically computed based on three levels. Herein, n=3, and a level interval g=⅓. In this case, a set weight corresponding to D1 is r1=3×g=1, a set weight corresponding to D2 is r2=(3-1)×g=⅔, and a set weight corresponding to D3 is r3=(3-2)×g=⅓.

In an embodiment, the determining the comprehensive quality evaluation score of the model instruction based on the set weight corresponding to each of the plurality of sample sets and the quality evaluation score of the model instruction in each sample set includes: superimposing the set weight corresponding to each sample set, to obtain a second superimposition weight; multiplying, for each of the plurality of sample sets, the quality evaluation score corresponding to the sample set by the corresponding set weight, to obtain a second multiplication score corresponding to the sample set; superimposing the second multiplication score corresponding to each sample set, to obtain a second superimposition score; and dividing the second superimposition score by the second superimposition weight, to obtain the comprehensive quality evaluation score of the model instruction.

Specifically, the computer device superimposes the set weight of each sample set, in other words, superimposes the set weights, to obtain the second superimposition weight. For example, for a sample set A, a sample set B, and a sample set C, a set weight corresponding to the sample set A is 1, a set weight corresponding to the sample set B is 0.5, and a set weight corresponding to the sample set C is 0.3. Therefore, the computer device superimposes 1, 0.5, and 0.3, to obtain a second superimposition weight 1.8. Further, because each sample set has a corresponding set weight and quality evaluation score, for each sample set, the computer device multiplies the set weight and the quality evaluation score that correspond to the sample set, to obtain a second multiplication score corresponding to the sample set. For example, when a quality evaluation score of the sample set A is 0.6, a quality evaluation score of the sample set B is 0.3, and a quality evaluation score of the sample set C is 0.2, a corresponding second multiplication score for the sample set A is 1×0.6=0.6, a corresponding second multiplication score for the sample set B is 0.5×0.3=0.15, and a corresponding second multiplication score for the sample set C is 0.3×0.2=0.06.

Further, the computer device superimposes the second multiplication score corresponding to each sample set, in other words, superimposes the second multiplication scores, to obtain a second superimposition score. For example, the computer device superimposes 0.6, 0.15, and 0.06, to obtain a second superimposition score 0.81. Further, the computer device divides the second superimposition score by the second superimposition weight, to obtain a comprehensive quality evaluation score. For example, the computer device divides 0.81 by 1.8, to obtain a comprehensive quality evaluation score 0.45.

In an embodiment, the computer device may determine a comprehensive quality evaluation score Sᵢ(T) of a model instruction pᵢ in full sample sets by using the following formula:

$$∀ {D}_{x} ∈ D , {S}_{i} ( T ) = \frac{{\sum }_{x = 1}^{n} {r}_{x} * {S}_{x i}}{{\sum }_{x = 1}^{\vert n \vert} {r}_{x}}$$

pᵢ represents an i^{th} model instruction in a model instruction set; rₓ is a set weight corresponding to a sample set Dₓ, where Dₓ represents an X^{th} sample set; Sₓᵢ is a quality evaluation score of the i^{th} model instruction in the X^{th} sample set; |n| is a total quantity of sample sets; and Sᵢ(T)∈[0,1], to be specific, a value range of Sᵢ(T) is a real number in a value range from 0 to 1. A higher comprehensive quality evaluation score indicates better quality of the model instruction evaluated based on the full sample sets; and a lower comprehensive quality evaluation score indicates lower quality of the model instruction evaluated based on the full sample sets.

In the foregoing embodiment, different sample sets have different importance. Therefore, the set weights are set, so that a more important sample set can be emphasized during the quality evaluation based on the set weights. In this way, a high-quality model instruction that is subsequently selected based on the comprehensive quality evaluation score can trigger the machine learning model to correctly process a sample similar to the important sample set.

For example, for the sample set A “short video comment data set” and the sample set B “ancient poem data set,” because a correlation between the sample set A and a positive and negative information recognition task is relatively high, a set weight of the sample set A is higher than a set weight of the sample set B. In this way, in a process of performing quality evaluation on a model instruction “About whether <sentence> is positive, neutral, or negative, please provide a result” based on the sample set A and the sample set B, a result of the quality evaluation on the model instruction based on the sample set A is more emphasized. The result of the quality evaluation on the model instruction based on the sample set A refers to the foregoing quality evaluation score corresponding to the sample set A. A more correct recognition result of performing positive and negative information recognition by the machine learning model on the sample set A indicates a higher quality evaluation score corresponding to the sample set A, and a higher quality evaluation score indicates a higher comprehensive quality evaluation score.

Compared with the sample set B, because the set weight of the sample set A is higher than that of the sample set B, an effect of the quality evaluation score corresponding to the sample set A on the comprehensive quality evaluation score is higher than an effect of the quality evaluation score corresponding to the sample set B on the comprehensive quality evaluation score. Therefore, compared with the sample set B, a more correct recognition result of performing positive and negative information recognition by the machine learning model on the sample set A indicates that the model instruction “About whether <sentence> is positive, neutral, or negative, please provide a result” is more likely to be a high-quality model instruction. Therefore, when the model instruction “About whether <sentence> is positive, neutral, or negative, please provide a result” is applied to actual production, a recognition result of performing, by the machine learning model, sentiment recognition on a text similar to the sample set A is more accurate, for example, a recognition result of performing positive and negative information recognition on a text like a real-time comment is more accurate.

In an embodiment, the method further includes: obtaining comprehensive quality evaluation scores of a plurality of model instructions, where the comprehensive quality evaluation score of each model instruction is determined according to the foregoing model instruction—quality evaluation method; selecting a high-quality model instruction from the plurality of model instructions based on the comprehensive quality evaluation scores of the plurality of model instructions; and; and triggering, according to the high-quality model instruction, the machine learning model to process a task.

Specifically, there may be a plurality of model instructions corresponding to the specified task. Therefore, for each model instruction, the computer device may obtain a comprehensive quality evaluation score corresponding to each model instruction according to the model instruction—quality evaluation method. For example, for a positive and negative information recognition task, there may be a model instruction A “Please determine sentiment polarity (positive/neutral/negative) of the sentence <sentence>,” a model instruction B “About whether <sentence> is positive, neutral, or negative, please provide a result,” a model instruction C “Please perform the following task, where content of the task is to classify a sentence into three categories: positive sentiment/neutral sentiment/negative sentiment, please directly output an analysis result, and a target sentence is: <sentence>,” and a model instruction D “We define sentence sentiments into positive polarity, neutral polarity, and negative polarity based on sentiment polarity, please provide a sentiment polarity result for the sentence <sentence>.” Then, the computer device may obtain a comprehensive quality evaluation score A of the model instruction A, a comprehensive quality evaluation score B of the model instruction B, and a comprehensive quality evaluation score C of the model instruction C according to the foregoing model instruction—quality evaluation method.

Further, the computer device may select a high-quality model instruction from the plurality of model instructions based on the comprehensive quality evaluation scores. During actual application, the machine learning model is triggered according to the high-quality model instruction to perform a corresponding task. For example, a model instruction whose comprehensive quality evaluation score is higher than a preset score threshold may be used as a high-quality model instruction. Alternatively, model instructions may be sorted in descending order of comprehensive quality evaluation scores, to obtain a model instruction sequence, first N model instructions in the model instruction sequence are used as high-quality model instructions, and the machine learning model is triggered according to the high-quality model instruction to perform positive and negative information recognition on another text.

In this embodiment, the high-quality model instruction is selected based on the comprehensive quality evaluation score, and the machine learning model may be triggered according to the high-quality model instruction to output a more accurate result, to improve accuracy of a model output result.

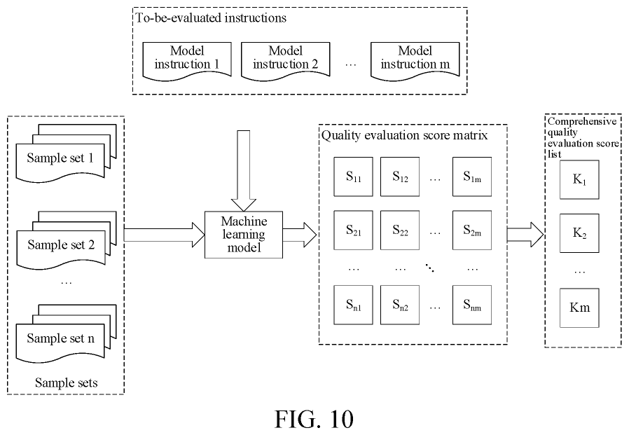

In an embodiment, FIG. 10 is a schematic diagram showing generating a plurality of comprehensive quality evaluation scores according to an embodiment. The computer device may perform quality evaluation on a plurality of model instructions by using a plurality of sample sets, to obtain a quality evaluation score matrix, and obtain, based on the quality evaluation score matrix, a comprehensive quality evaluation score corresponding to each model instruction. Sij represents a quality evaluation score of a model instruction j in a sample set j; and Kj represents a comprehensive quality evaluation score of the model instruction j.

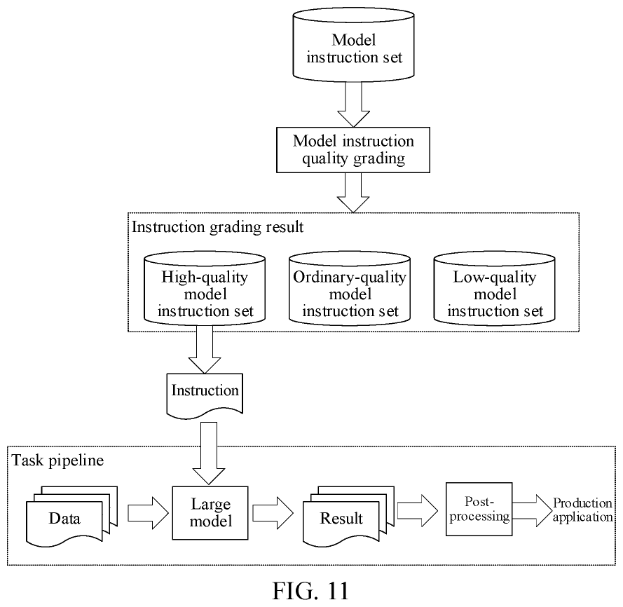

In an embodiment, refer to FIG. 11. A plurality of model instructions of the machine learning model may be graded based on comprehensive quality evaluation scores corresponding to the model instructions, to obtain a high-quality model instruction set, an ordinary-quality model instruction set, and a low-quality model instruction set. The machine learning model is triggered in a task pipeline according to the high-quality model instruction set to perform a corresponding task, to obtain a task execution result, post-processing is performed on the task execution result, to obtain a processing result, and the processing result is applied to a production application. For example, the machine learning model may be a large model used for positive and negative information recognition. During actual production application, positive and negative information analysis may be performed on public real-time comments during application by using the large model. When a high-quality model instruction is obtained, during actual application production, public real-time comments of the application may be obtained in real time, and a large model is triggered according to the high-quality model instruction to perform positive and negative information recognition on the public real-time comments, to obtain positive and negative information recognition results. FIG. 11 is a schematic diagram showing applying a high-quality model instruction according to an embodiment.

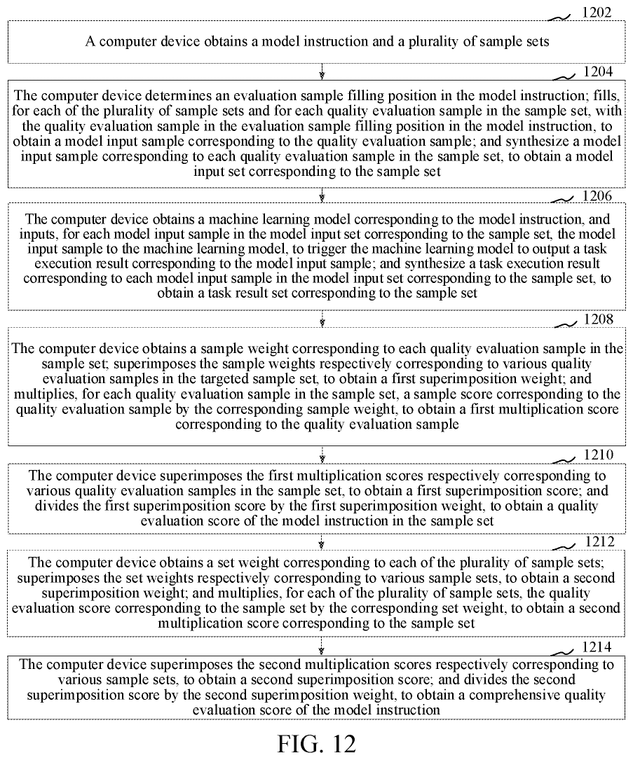

In an embodiment, FIG. 12 is a flowchart of a model instruction—quality evaluation method according to a specific embodiment. The model instruction—quality evaluation method includes:

Operation 1202: A computer device obtains a model instruction and a plurality of sample sets.

Operation 1204: The computer device determines an evaluation sample filling position in the model instruction; fills, for each of the plurality of sample sets and for each quality evaluation sample in the sample set, with the quality evaluation sample, in the evaluation sample filling position in the model instruction, to obtain a model input sample corresponding to the quality evaluation sample; and synthesize a model input sample corresponding to each quality evaluation sample in the sample set, to obtain a model input set corresponding to the sample set.

Operation 1206: The computer device obtains a machine learning model corresponding to the model instruction, and inputs, for each model input sample in the model input set corresponding to the sample set, the model input sample to the machine learning model, to trigger the machine learning model to output a task execution result corresponding to the model input sample; and synthesize a task execution result corresponding to each model input sample in the model input set corresponding to the sample set, to obtain a task result set corresponding to the sample set.

Operation 1208: The computer device obtains a sample weight corresponding to each quality evaluation sample in the sample set; superimposes the sample weights respectively corresponding to various quality evaluation samples in the sample set, to obtain a first superimposition weight; and multiplies, for each quality evaluation sample in the sample set, a sample score corresponding to the quality evaluation sample by the corresponding sample weight, to obtain a first multiplication score corresponding to the quality evaluation sample.

Operation 1210: The computer device superimposes the first multiplication scores respectively corresponding to various quality evaluation samples in the sample set, to obtain a first superimposition score; and divides the first superimposition score by the first superimposition weight, to obtain a quality evaluation score of the model instruction in the sample set.

Operation 1212: The computer device obtains a set weight corresponding to each of the plurality of sample sets; superimposes the set weights respectively corresponding to various sample sets, to obtain a second superimposition weight; and multiplies, for each of the plurality of sample sets, the quality evaluation score corresponding to the sample set by the corresponding set weight, to obtain a second multiplication score corresponding to the sample set.

Operation 1214: The computer device superimposes the second multiplication scores respectively corresponding to various sample sets, to obtain a second superimposition score; and divides the second superimposition score by the second superimposition weight, to obtain a comprehensive quality evaluation score of the model instruction.

It will be appreciated that, although the various steps in the flowcharts involved in the embodiments as described above are shown in sequence as indicated by the arrows, these steps are not necessarily performed in the order indicated by the arrows. Unless otherwise explicitly specified in this application, execution of the steps is not strictly limited, and the steps may be performed in other sequences. Moreover, at least some of the steps in the flowcharts involved in the embodiments as described above may include a plurality of steps or a plurality of stages. These steps or stages are not necessarily performed at the same moment, but may be performed at different moments. These steps or stages are not necessarily performed in sequence, but may be performed in turn or in alternation with other steps or at least some of the steps or stages in other steps.

This application further provides an application scenario. The foregoing model instruction—quality evaluation method is applied to the application scenario. Specifically, the model instruction—quality evaluation method is applied to the application scenario as follows:

When a large model is a palm print recognition model, a computer device may obtain a plurality of model instructions and a plurality of sample sets, for example, obtain an animal palm print set obtained by collecting images for palm prints of animals, and obtain a human palm print set obtained by collecting images for palm prints of humans. Further, according to the foregoing method, the computer device selects a high-quality model instruction from the plurality of model instructions based on the plurality of sample sets, and triggers, according to the high-quality model instruction, a palm print recognition model to recognize a palm print image during production application.

This application further provides an application scenario. The foregoing model instruction—quality evaluation method is applied to the application scenario. Specifically, the model instruction—quality evaluation method is applied to the application scenario as follows:

When a large model is a dialog generation model, a computer device may obtain a plurality of model instructions and a plurality of sample sets, for example, obtain a plurality of dialog sets. Further, according to the foregoing method, the computer device selects a high-quality model instruction from the plurality of model instructions based on the plurality of sample sets, and triggers, according to the high-quality model instruction, a dialog generation model to automatically have a dialog with a user during production application.

The above application scenarios are merely exemplary illustrations. The application of the model instruction—quality evaluation method provided in the embodiments of this application is not limited to the above scenarios. For example, the foregoing model instruction—quality evaluation method may further be applied to a specific field, such as health/finance/scientific research/education.

Beneficial effects of the foregoing model instruction—quality evaluation method include:
1. An appropriate model instruction set is constructed for an existing large model in a specified task background, and there is currently no method about how to automatically evaluate quality of a model instruction and select a high-quality model instruction. However, in this application, quality evaluation may be automatically performed on a model instruction, and a high-quality model instruction may be automatically selected.
2. Quality of a model instruction greatly affects a final execution effect of a machine learning model. For example, for a task like a positive and negative information recognition task, or a sentiment analysis task, how to formulate an instruction to enable a large model to perform the task currently mainly relies on manual experience. Such a method necessarily causes uncertainty to a task effect. However, in this application, a high-quality model instruction is selected, and a large model may be guided, based on the high-quality model instruction, to output an expected result.

Based on a same concept, an embodiment of this application further provides a model instruction—quality evaluation apparatus configured to implement the foregoing related model instruction—quality evaluation method. An implementation solution to the problem provided by the apparatus is similar to the implementation solution recorded in the foregoing method. Therefore, for specific limitations in one or more model instruction—quality evaluation apparatus embodiments provided below, refer to the limitations on the foregoing model instruction—quality evaluation method. Details are not described herein again.

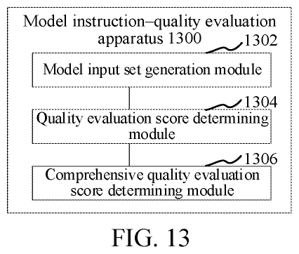

In an embodiment, as shown in FIG. 13, a model instruction—quality evaluation apparatus 1300 is provided. The apparatus includes: a model input set generation module 1302, a quality evaluation score determining module 1304, and a comprehensive quality evaluation score determining module 1306.

The model input set generation module 1302 is configured to: obtain a model instruction and a plurality of sample sets; and fuse, for each of the plurality of sample sets, the model instruction with each quality evaluation sample in the sample set, to obtain a model input set corresponding to the sample set.

The quality evaluation score determining module 1304 is configured to: obtain a machine learning model corresponding to the model instruction, and trigger, based on the model input set corresponding to the sample set, the machine learning model to perform a specified task, to obtain a task result set, the specified task being a task, specified by the model instruction, to be performed by the machine learning model; and determine, based on accuracy of each task execution result in the task result set, a quality evaluation score that is of the model instruction and that is obtained by evaluation based on the sample set.

The comprehensive quality evaluation score determining module 1306 is configured to determine a comprehensive quality evaluation score of the model instruction based on the quality evaluation score obtained by evaluation based on each sample set.

In the foregoing embodiment, the to-be-evaluated model instruction and the plurality of sample sets are obtained, so that the model instruction can be fused with each quality evaluation sample in each sample set, to obtain the model input set corresponding to each sample set. The model input set is obtained. For each of the plurality of sample sets, the task result set corresponding to the sample set may be outputted based on the machine learning model, and the quality evaluation score obtained by evaluation based on the sample set is obtained based on the accuracy of the task execution result in the task result set. The quality evaluation score obtained by evaluation based on each sample set is obtained, so that the comprehensive quality evaluation score of the model instruction can be obtained based on the quality evaluation score. Because the comprehensive quality evaluation score can be obtained automatically, compared with the approach of manually performing quality evaluation on a model instruction, this application can greatly improve evaluation efficiency of the quality evaluation. In addition, this application can be widely applied to actual production of large model instruction projects, and a large model is triggered, by searching for a high-quality model instruction, to output a more accurate result. In addition, compared with determining a comprehensive quality evaluation score based on only one sample set, jointly determining the comprehensive quality evaluation score of the model instruction based on the plurality of sample sets can reduce a probability that quality evaluation is inaccurate due to an excessively small quantity of sample sets, to improve accuracy of the model instruction—quality evaluation.

In an embodiment, the model input set includes a model input sample corresponding to each quality evaluation sample in the sample set. The model input set generation module 1302 is further configured to: determine an evaluation sample filling position in the model instruction based on a preset keyword; and fill, for each quality evaluation sample in the sample set, the quality evaluation sample in the evaluation sample filling position in the model instruction, to obtain the model input sample corresponding to the quality evaluation sample.

In an embodiment, the task result set includes a task execution result corresponding to each model input sample in the model input set. The quality evaluation score determining module 1304 is further configured to input, for each model input sample in the model input set corresponding to the sample set, the model input sample to the machine learning model, to trigger the machine learning model to output the task execution result corresponding to the model input sample.

In an embodiment, the quality evaluation score determining module 1304 is further configured to: obtain a sample weight corresponding to each quality evaluation sample in the sample set; determine accuracy of each task execution result in the task result set; and determine, based on the sample weight corresponding to each quality evaluation sample in the sample set and the accuracy of each task execution result in the task result set, the quality evaluation score of the model instruction in the sample set.

In an embodiment, the model instruction—quality evaluation apparatus 1300 further includes a sample weight generation module, configured to: select a preset quantity of quality evaluation samples from each sample set; add a sample weight to the selected quality evaluation sample; train a logistic regression model by using the selected quality evaluation sample and the added sample weight, to obtain a trained logistic regression model; and determine, based on the trained logistic regression model, a sample weight corresponding to a non-selected quality evaluation sample.

In an embodiment, the model instruction—quality evaluation apparatus 1300 further includes a sample weight generation module, configured to: determine a sample feature of the non-selected quality evaluation sample; obtain a model parameter matrix of the trained logistic regression model, and fuse the model parameter matrix with the sample feature, to obtain a fusion feature corresponding to the non-selected quality evaluation sample; and normalize the fusion feature, to obtain the sample weight corresponding to the non-selected quality evaluation sample.

In an embodiment, the quality evaluation score determining module 1304 is further configured to: determine, for each task execution result in the task result set, a quality evaluation sample that corresponds to the task execution result and that is in the sample set, and determine, based on the accuracy of the task execution result, a sample score corresponding to the corresponding quality evaluation sample; and determine, based on the sample weight and the sample score that correspond to each quality evaluation sample in the sample set, the quality evaluation score that is of the model instruction and that is obtained by evaluation based on the sample set.

In an embodiment, the quality evaluation score determining module 1304 is further configured to: determine, when the task execution result is correct, that the sample score corresponding to the corresponding quality evaluation sample is a first score; and determine, when the task execution result is incorrect, that the sample score corresponding to the corresponding quality evaluation sample is a second score, the first score being greater than the second score.

In an embodiment, the quality evaluation score determining module 1304 is further configured to: add the sample weight corresponding to each quality evaluation sample in the sample set, to obtain a first superimposition weight; multiply, for each quality evaluation sample in the sample set, the sample score corresponding to the quality evaluation sample by the corresponding sample weight, to obtain a first multiplication score corresponding to the quality evaluation sample; add the first multiplication score corresponding to each quality evaluation sample in the sample set, to obtain a first superimposition score; and divide the first superimposition score by the first superimposition weight, to obtain the quality evaluation score that is of the model instruction and that is obtained by evaluation based on the sample set.

In an embodiment, the comprehensive quality evaluation score determining module 1306 is further configured to obtain a set weight corresponding to each of the plurality of sample sets; and determine the comprehensive quality evaluation score of the model instruction based on the set weight corresponding to each of the plurality of sample sets and the quality evaluation score obtained by evaluation based on each sample set.

In an embodiment, the model instruction—quality evaluation apparatus 1300 further includes a set weight generation module, configured to: determine, according to the model instruction, the specified task that needs to be performed by the machine learning model; determine a correlation degree between each sample set and the specified task; and determine, based on the correlation degree between each sample set and the specified task, the set weight corresponding to each sample set.

In an embodiment, the model instruction—quality evaluation apparatus 1300 further includes a set weight generation module, configured to: determine task description information of the specified task, a sample set identifier of each sample set, and a selected sample in each sample set; generate a construction instruction based on the task description information, the sample set identifier of each sample set, and the selected sample in each sample set; and determine, according to the construction instruction, the correlation degree between each sample set and the specified task.

In an embodiment, the model instruction—quality evaluation apparatus 1300 further includes a set weight generation module, configured to: obtain an initial construction instruction, the initial construction instruction including an information filling index, a set filling index corresponding to each sample set, and a selected sample filling index corresponding to each sample set; and fill the task description information in a position indicated by the information filling index, fill the sample set identifier of each sample set in a position indicated by the corresponding set filling index, and fill a sample identifier of each selected sample in a position indicated by the corresponding selected sample filling index, to obtain the construction instruction.

In an embodiment, the model instruction—quality evaluation apparatus 1300 further includes a set weight generation module, configured to: determine a quantity of sample sets in the plurality of sample sets, and determine a level interval based on the quantity; sort the sample sets in the plurality of sample sets in descending order of the correlation degrees, to obtain a sample set sequence; and determine, based on the level interval and a ranking of each sample set in the sample set sequence, the set weight corresponding to each sample set.

In an embodiment, the comprehensive quality evaluation score determining module 1306 is further configured to: add the set weight corresponding to each sample set, to obtain a second superimposition weight; multiply, for each of the plurality of sample sets, the quality evaluation score corresponding to the sample set by the corresponding set weight, to obtain a second multiplication score corresponding to the sample set; add the second multiplication score corresponding to each sample set, to obtain a second superimposition score; and divide the second superimposition score by the second superimposition weight, to obtain the comprehensive quality evaluation score of the model instruction.

In an embodiment, the model instruction—quality evaluation apparatus 1300 further includes a high-quality instruction determining module, configured to: obtain comprehensive quality evaluation scores of a plurality of model instructions; select a high quality model instruction from the plurality of model instructions based on the comprehensive quality evaluation scores of the plurality of model instructions; and trigger, according to the high-quality model instruction, the machine learning model to process a task.

All or part of the modules in the foregoing model instruction—quality evaluation apparatus may be implemented by using software, hardware, or a combination thereof. The modules may be built in or independent from a processor in a computer device in a form of hardware, or may be stored in a memory in a computer device in a form of software, so that a processor can invoke and perform operations corresponding to the modules. Moreover, each module can be part of an overall module that includes the functionalities of the module.

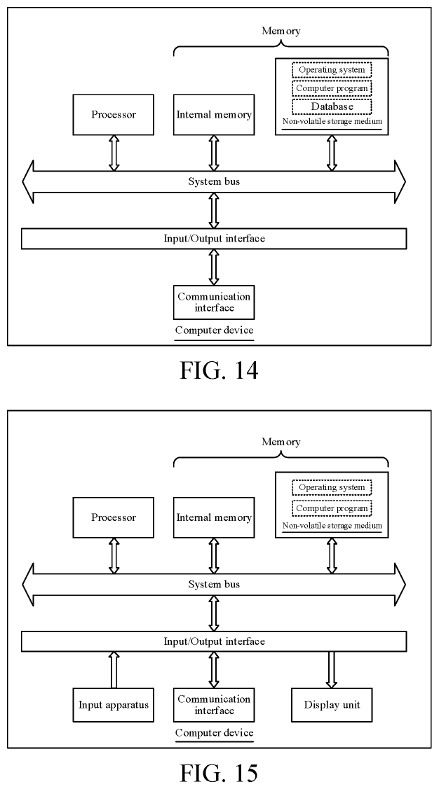

In an embodiment, a computer device is provided. The computer device may be a server, and a diagram showing an internal structure thereof may be shown in FIG. 14. The computer device includes a processor, a memory, an input/output (briefly referred to as I/O) interface, and a communication interface. The processor, the memory, and the input/output interface are connected to each other through a system bus, and the communication interface is connected to the system bus through the input/output interface. The processor of the computer device is configured to provide computation and control capabilities. The memory of the computer device includes a non-volatile storage medium and an internal memory. The non-volatile storage medium stores an operating system, a computer program, and a database. The internal memory provides an environment for operation of the operating system and the computer program in the non-volatile storage medium. The database of the computer device is configured to store data. The input/output interface of the computer device is configured to exchange information between the processor and an external device. The communication interface of the computer device is configured to connect and communicate with an external terminal via a network. The computer program, when executed by the processor, implements a model instruction—quality evaluation method.

In an embodiment, a computer device is provided. The computer device may be a terminal, and a diagram showing an internal structure thereof may be shown in FIG. 15. The computer device includes a processor, a memory, an input/output interface, a communication interface, a display unit, and an input apparatus. The processor, the memory, and the input/output interface are connected to each other through a system bus, and the communication interface, the display unit, and the input apparatus are connected to the system bus through the input/output interface. The processor of the computer device is configured to provide computation and control capabilities. The memory of the computer device includes a non-volatile storage medium and an internal memory. The non-volatile storage medium stores an operating system and a computer program. The internal memory provides an environment for operation of the operating system and the computer program in the non-volatile storage medium. The input/output interface of the computer device is configured to exchange information between the processor and an external device. The communication interface of the computer device is configured to communicate with an external terminal in a wired or wireless manner. The wireless manner may be implemented by wireless fidelity (Wi-Fi), a mobile cellular network, near field communication (NFC), or another technology. The computer program, when executed by the processor, implements a model instruction—quality evaluation method. The display unit of the computer device may be configured to form a visually visible screen and may be a display screen, a projection apparatus, or a virtual reality imaging apparatus. The display screen may be a liquid crystal display screen or an e-ink display screen. The input apparatus of the computer device may be a touch layer covering the display screen, or may be a button, a trackball, or a touchpad disposed on a housing of the computer device, or may be an external keyboard, touchpad, mouse or the like.

A person skilled in the art may understand that, the structures shown in FIG. 14 and FIG. 15 are merely block diagrams of partial structures related to the solution in this application, and does not constitute a limitation to the computer device to which the solution in this application is applied. Specifically, the computer device may include more or fewer components than those shown in the figure, or have some components combined, or have a different component deployment.

In an embodiment, a computer device is provided. The computer device includes a memory and a processor. The memory having computer-readable instructions stored herein. The processor, when executing the computer-readable instructions, implements the steps in the foregoing method embodiments.

In an embodiment, a computer-readable storage medium is provided. The computer-readable storage medium having computer-readable instructions stored therein. The computer-readable instructions, when executed by a processor, implement the operations in the foregoing method embodiments.

In an embodiment, a computer program product or a computer program is provided. The computer program product or the computer program includes computer-readable instructions. The computer-readable instructions are stored in a computer-readable storage medium. A processor of a computer device reads the computer-readable instructions from the computer-readable storage medium, and the processor executes the computer-readable instructions, so that the computer device performs the steps of the foregoing method embodiments.

User information (including, but not limited to, information about user equipment, user personal information, and the like) and data (including, but not limited to, data for analysis, stored data, displayed data, and the like) involved in this application are all information and data authorized by a user or fully authorized by all parties, and collection, use, and processing of relevant data need to comply with relevant laws, regulations, and standards of relevant countries and regions.

A person of ordinary skill in the art may understand that all or some of procedures of the method in the foregoing embodiments may be implemented by a computer program instructing relevant hardware. The computer program may be stored in a non-volatile computer-readable storage medium. When the computer program is executed, the procedures of the foregoing method embodiments may be implemented. Any reference to a memory, a database, or other media used in the embodiments provided in this application may include at least one of a non-volatile memory and a volatile memory. The non-volatile memory may include a read-only memory (ROM), a magnetic tape, a floppy disk, a flash memory, an optical memory, a high-density embedded non-volatile memory, a resistive random-access memory (ReRAM), a magnetoresistive random-access memory (MRAM), a ferroelectric random-access memory (FRAM), a phase change memory (PCM), a graphene memory, and the like. The volatile memory may include a random-access memory (RAM) or an external cache. For the purpose of illustration but not limitation, RAM is available in many forms, for example, static random access memory (SRAM) or dynamic random access memory (DRAM), and so on. The databases involved in various embodiments provided in this application may include at least one of a relational database and a non-relational database. The non-relational database may include, but is not limited to, a blockchain-based distributed database and the like. The processors involved in the various embodiments provided by this application can be general-purpose processors, central processing units, graphics processors, digital signal processors, programmable logic devices, data processing logic devices based on quantum computing, and are not limited thereto.

Technical features of the foregoing embodiments may be randomly combined. To make description concise, not all possible combinations of the technical features in the foregoing embodiments are described. However, the combinations of these technical features shall be considered as falling within the scope recorded by this specification provided that no conflict exists.

The foregoing embodiments show only several implementations of this application and are described in detail, which, however, are not to be construed as a limitation to the patent scope of this application. For a person of ordinary skill in the art, several transformations and improvements can be made without departing from the idea of this application. These transformations and improvements belong to the protection scope of this application. Therefore, the protection scope of this application shall be subject to the appended claims. To make the objectives, technical solutions, and advantages of this application clearer, the following further describes this application in detail with reference to the accompanying drawings and the embodiments. The specific embodiments described herein are only used for explaining this application, and are not used for limiting this application.

What is claimed is:

1. A model instruction—quality evaluation method, performed by a computer device, and comprising:
obtaining a model instruction and a plurality of sample sets;
for each sample set of the plurality of sample sets:
fusing the model instruction with each quality evaluation sample in the sample set, to obtain a model input set corresponding to the sample set;
triggering, based on the model input set corresponding to the sample set, a machine learning model corresponding to the model instruction to perform a specified task, to obtain a task result set, the specified task being specified by the model instruction and to be performed by the machine learning model; and
determining, based on accuracy of each task execution result in the task result set, a quality evaluation score of the model instruction; and
determining a comprehensive quality evaluation score of the model instruction based on the quality evaluation scores obtained by evaluation based on the plurality of sample sets.

2. The method according to claim 1, wherein:
the model input set includes a model input sample corresponding to each quality evaluation sample in the sample set; and
fusing the model instruction with each quality evaluation sample in the sample set includes:
determining an evaluation sample filling position in the model instruction based on a preset keyword; and
filling, for each quality evaluation sample in the sample set, the quality evaluation sample in the evaluation sample filling position in the model instruction, to obtain the model input sample corresponding to the quality evaluation sample.

3. The method according to claim 1, wherein:
the task result set includes a task execution result corresponding to each model input sample in the model input set; and
triggering the machine learning model to perform the specified task includes:
inputting, for each model input sample in the model input set corresponding to the sample set, the model input sample to the machine learning model, to trigger the machine learning model to output the task execution result corresponding to the model input sample.

4. The method according to claim 1, wherein determining the quality evaluation score includes:
obtaining a sample weight corresponding to each quality evaluation sample in the sample set;
determining the accuracy of each task execution result in the task result set; and
determining, based on the sample weight corresponding to each quality evaluation sample in the sample set and the accuracy of each task execution result in the task result set, the quality evaluation score of the model instruction in the sample set.

5. The method according to claim 4, further comprising:
selecting one or more quality evaluation samples from each sample set;
adding a sample weight to each of the one or more selected quality evaluation samples;
training a logistic regression model using the one or more selected quality evaluation samples and the sample weight of each of the one or more selected quality evaluation samples, to obtain a trained logistic regression model; and
determining, based on the trained logistic regression model, a sample weight corresponding to a non-selected quality evaluation sample in the sample set.

6. The method according to claim 5, wherein determining the sample weight corresponding to the non-selected quality evaluation sample includes:
determining a sample feature of the non-selected quality evaluation sample;
fusing a model parameter matrix of the trained logistic regression model with the sample feature, to obtain a fusion feature corresponding to the non-selected quality evaluation sample; and
normalizing the fusion feature, to obtain the sample weight corresponding to the non-selected quality evaluation sample.

7. The method according to claim 4, wherein determining, based on the sample weight corresponding to each quality evaluation sample in the sample set and the accuracy of each task execution result in the task result set, the quality evaluation score of the model instruction includes:
for each task execution result in the task result set, determining, from the sample set, a quality evaluation sample that corresponds to the task execution result, and determining, based on the accuracy of the task execution result, a sample score corresponding to the quality evaluation sample; and
determining, based on the sample weight and the sample score corresponding to each quality evaluation sample in the sample set, the quality evaluation score of the model instruction.

8. The method according to claim 7, wherein determining the sample score includes:
determining, in response to the task execution result being correct, that the sample score corresponding to the quality evaluation sample is a first score; and
determining, in response to the task execution result being incorrect, that the sample score corresponding to the quality evaluation sample is a second score smaller than the first score.

9. The method according to claim 7, wherein determining the quality evaluation score includes:
superimposing the sample weights corresponding to the quality evaluation samples in the sample set, to obtain a superimposition weight;
multiplying, for each quality evaluation sample in the sample set, the sample score corresponding to the quality evaluation sample by the corresponding sample weight, to obtain a multiplication score corresponding to the quality evaluation sample;
superimposing the multiplication scores corresponding to the quality evaluation samples in the sample set, to obtain a superimposition score; and
dividing the superimposition score by the superimposition weight, to obtain the quality evaluation score of the model instruction.

10. The method according to claim 1, wherein determining the comprehensive quality evaluation score includes:
obtaining a set weight corresponding to each of the plurality of sample sets; and
determining the comprehensive quality evaluation score of the model instruction based on the set weights corresponding to the plurality of sample sets and the quality evaluation scores obtained based on the plurality of sample sets.

11. The method according to claim 10, further comprising:
determining, according to the model instruction, the specified task; and
for each sample set of the plurality of sample sets:
determining a correlation degree between the sample set and the specified task; and
determining, based on the correlation degree, the set weight corresponding to the sample set.

12. The method according to claim 11, wherein determining the correlation degree includes:
determining task description information of the specified task, a sample set identifier of the sample set, and a selected sample in the sample set;
generating a construction instruction based on the task description information, the sample set identifier, and the selected sample; and
determining, according to the construction instruction, the correlation degree.

13. The method according to claim 12, wherein generating the construction instruction includes:
obtaining an initial construction instruction that includes an information filling index, a set filling index corresponding to the sample set, and a selected sample filling index corresponding to the sample set; and
filling the task description information in a position indicated by the information filling index, filling the sample set identifier in a position indicated by the set filling index, and filling a sample identifier of the selected sample in a position indicated by the selected sample filling index, to obtain the construction instruction.

14. The method according to claim 11, wherein determining the set weight for each sample set includes:
determining a quantity of the plurality of sample sets, and determining a level interval based on the quantity;
sorting the plurality of sample sets in a descending order of the correlation degrees, to obtain a sample set sequence; and
for each sample set, determining, based on the level interval and a ranking of the sample set in the sample set sequence, the set weight corresponding to the sample set.

15. The method according to claim 10, wherein determining the comprehensive quality evaluation score of the model instruction based on the set weights and the quality evaluation scores includes:
superimposing the set weights to obtain a superimposition weight;
multiplying, for each of the plurality of sample sets, the quality evaluation score corresponding to the sample set by the corresponding set weight, to obtain a multiplication score corresponding to the sample set;
superimposing the multiplication scores corresponding to the plurality of sample sets, to obtain a superimposition score; and
dividing the superimposition score by the superimposition weight, to obtain the comprehensive quality evaluation score of the model instruction.

16. The method according to claim 1,
wherein the model instruction is one of a plurality of model instructions;
the method further comprising:
obtaining comprehensive quality evaluation scores of the plurality of model instructions, respectively;
selecting a high-quality model instruction from the plurality of model instructions based on the comprehensive quality evaluation scores of the plurality of model instructions; and
triggering, by the high-quality model instruction, the machine learning model to process a task.

17. A computer device comprising:
a memory storing computer-readable instructions; and
a processor configured to execute the computer-readable instructions to:
obtain a model instruction and a plurality of sample sets;
for each sample set of the plurality of sample sets:
fuse the model instruction with each quality evaluation sample in the sample set, to obtain a model input set corresponding to the sample set;
trigger, based on the model input set corresponding to the sample set, a machine learning model corresponding to the model instruction to perform a specified task, to obtain a task result set, the specified task being specified by the model instruction and to be performed by the machine learning model; and
determine, based on accuracy of each task execution result in the task result set, a quality evaluation score of the model instruction; and
determine a comprehensive quality evaluation score of the model instruction based on the quality evaluation scores obtained by evaluation based on the plurality of sample sets.

18. The computer device according to claim 17, wherein:
the model input set includes a model input sample corresponding to each quality evaluation sample in the sample set; and
the processor is further configured to execute the computer-readable instructions to, when fusing the model instruction with each quality evaluation sample in the sample set:
determine an evaluation sample filling position in the model instruction based on a preset keyword; and
fill, for each quality evaluation sample in the sample set, the quality evaluation sample in the evaluation sample filling position in the model instruction, to obtain the model input sample corresponding to the quality evaluation sample.

19. The computer device according to claim 17, wherein:
the task result set includes a task execution result corresponding to each model input sample in the model input set; and
the processor is further configured to execute the computer-readable instructions to, when triggering the machine learning model to perform the specified task:
inputting, for each model input sample in the model input set corresponding to the sample set, the model input sample to the machine learning model, to trigger the machine learning model to output the task execution result corresponding to the model input sample.

20. A non-transitory computer-readable storage medium storing computer-readable instructions stored that, when executed by a processor, cause an electronic device including the processor to:
obtain a model instruction and a plurality of sample sets;
for each sample set of the plurality of sample sets:
fuse the model instruction with each quality evaluation sample in the sample set, to obtain a model input set corresponding to the sample set;
trigger, based on the model input set corresponding to the sample set, a machine learning model corresponding to the model instruction to perform a specified task, to obtain a task result set, the specified task being specified by the model instruction and to be performed by the machine learning model; and
determine, based on accuracy of each task execution result in the task result set, a quality evaluation score of the model instruction; and
determine a comprehensive quality evaluation score of the model instruction based on the quality evaluation scores obtained by evaluation based on the plurality of sample sets.
